(19) United States
(12) Patent Application Publication
(10) Pub. No.: US 2022/0222543 A1
(43) Pub. Date: Jul. 14, 2022

(54) Information Matching Using Subgraphs

(71) Applicant: International Business Machines Corporation, Armonk, NY (US)

(72) Inventors: Mohammad Khatibi, Richmond Hill (CA); Eitan Daniel Farchi, Pardes Hana (IL); Martin Oberhofer, Sindelfingen (DE)

(21) Appl. No.: 17/148,412

(22) Filed: Jan. 13, 2021

(51) Int. Cl. G06N 5/02; G06K 9/62

(52) U.S. Cl. CPC G06N 5/02; G06K 9/6276; G06K 9/6224; G06K 9/6271; G06K 9/6215

(57) ABSTRACT

A method matches information. A first center node in a first subgraph and a second center node in a second subgraph are identified. Groups of neighboring nodes having the neighboring nodes from both of subgraphs are identified. A group of the neighboring nodes in the groups has the neighboring nodes with a same node type. A best matching node pair of the neighboring nodes in each cluster is identified. The neighboring nodes in each best matching node pair comprise a first node from the first subgraph and a second node from the second subgraph. Whether the center nodes match is determined based on an overall distance between the center nodes using the first and second center node and the best matching node pair pairs.

### BACKGROUND

### 1. Field

The disclosure relates generally to an improved computer system and, more specifically, to a method, apparatus, system, and computer program product for matching subgraphs.

### 2. Description of the Related Art

Companies and other organizations have many data sources. These data sources contain records for persons, organizations, suppliers, products, marketing plans, or other types of items. These records are often maintained in multiple operational systems that process day-to-day transactions of a company. These records are moved or accessed by analytical systems to produce reports. These reports include revenue by customer, revenue by product, sales trends, usage reports, or other types of reports. In generating reports in analytical systems, duplicate records can cause inaccuracies in the analysis and resulting reports. As a result, the duplicate records in the data are identified and reconciled in order to meet reporting requirements.

Software matching algorithms have been used to identify duplicate records within or across different data sets. These matching algorithms implement, for example, deterministic matching, fuzzy probabilistic matching, and other types of matching processes. These software matching algorithms focus on relational and column data structures for the records to determine whether duplicate records are present. As the number of records that are compared increases, the amount of time and resource use can increase dramatically.

Therefore, it would be desirable to have a method and apparatus that take into account at least some of the issues discussed above, as well as other possible issues. For example, it would be desirable to have a method and apparatus that overcome a technical problem with the amount of time and resources needed to match large numbers of records.

### SUMMARY

According to one embodiment of the present invention, a method matches information. A first center node in a first subgraph and a second center node in a second subgraph are identified by a computer system. Groups of neighboring nodes having the neighboring nodes from both the first subgraph and the second subgraph are identified by the computer system. A group of the neighboring nodes in the groups of the neighboring nodes has the neighboring nodes with a same node type. A best matching node pair of the neighboring nodes is identified by the computer system in each group of the neighboring nodes to form a set of best matching node pairs in the set of clusters, wherein each best matching node pair comprises a first neighboring node from the first subgraph and a second neighboring node from the second subgraph. Whether the first center node and the second center node match using the first center node, the second center node, and the set of best matching node pairs in the set of clusters is determined by the computer system.

According to another embodiment of the present invention, a method matches information. A computer system allocates neighboring nodes of two center nodes in two subgraphs into groups by a node type, wherein the groups contain the neighboring nodes from both of the two subgraphs. The computer system selects a best matching node pair of the neighboring nodes for each group of neighboring nodes using a Hausdorff distance to form a set of best matching node pairs of the neighboring nodes for the group of the neighboring nodes, wherein a best matching node pair in the set of best matching node pairs has a neighboring node from each of the two subgraphs. The computer system determines an overall distance between the two center nodes using the two center nodes and the set of best matching node pairs of the neighboring nodes. The overall distance between the two center nodes takes into account the set of best matching node pairs for each of the two center nodes. The computer system determines whether a match is present between the two center nodes based on the overall distance between the two center nodes.

According to yet another embodiment of the present invention, an information management system comprises a computer system that executes program instructions to identify a first center node in a first subgraph and a second center node in a second subgraph. The computer system executes the program instructions to identify groups of neighboring nodes having the neighboring nodes from both the first subgraph and the second subgraph. A group of the neighboring nodes in the groups of the neighboring nodes has the neighboring nodes with a same node type. The computer system executes the program instructions to identify a best matching node pair of the neighboring nodes in each group of the neighboring nodes to form a set of best matching node pairs in. Each best matching node pair comprises a first neighboring node from the first subgraph and a second neighboring node from the second subgraph. The computer system executes the program instructions to determine whether the first center node and the second center node match using the first center node, the second center node, and the set of best matching node pairs.

According to still another embodiment of the present invention, an information management system comprises a computer system that executes program instructions to allocate neighboring nodes of two center nodes in two subgraphs into groups by a node type. The groups contain the neighboring nodes from both of the two subgraphs. The computer system executes the program instructions to select a best matching node pair of the neighboring nodes for each group of the neighboring nodes using a Hausdorff distance to form a set of best matching node pairs of the neighboring nodes for the set of clusters. A best matching node pair in the set of best matching node pairs has a neighboring node from each of the two subgraphs. The computer system executes the program instructions to determine an overall distance between the two center nodes using the two center nodes and the set of best matching node pairs of the neighboring nodes. The overall distance between the two center nodes takes into account the set of best matching node pairs for each of the two center nodes. The computer system executes the program instructions to determine whether a match is present between the two center nodes based on the overall distance between the two center nodes.

According to yet another embodiment of the present invention, a computer program product for matching information comprises a computer-readable storage medium having program instructions embodied therewith. The program instructions are executable by a computer system to cause the computer to perform a method comprising identifying, by the computer system, a first center node in a first subgraph and a second center node in a second subgraph; identifying, by the computer system, groups of neighboring nodes having the neighboring nodes from both the first subgraph and the second subgraph, wherein a group of the neighboring nodes in the groups of the neighboring nodes has the neighboring nodes with a same node type; identifying, by the computer system, a best matching node pair of the neighboring nodes in each group of the neighboring nodes to form a set of best matching node pairs in the set of clusters, wherein the neighboring nodes in the best matching node pair comprise a first neighboring node from the first subgraph and a second neighboring node from the second subgraph; and determining, by the computer system, whether the first center node and the second center node match using the first center node, the second center node, and the set of best matching node pairs in the set of clusters.

Thus, the different illustrative embodiments can reduce at least one of time or resources used in determining whether pieces of information are matching as compared to current techniques that do not compare subgraphs. Further, different illustrative examples can also increase the accuracy in matching pieces of information in at least first order matching or first second order matching.

### BRIEF DESCRIPTION OF THE DRAWINGS

FIG. 1 is a pictorial representation of a network of data processing systems in which illustrative embodiments may be implemented;

FIG. 2 is a set of functional abstraction layers provided by cloud computing environment 50 in FIG. 1 in accordance with an illustrative embodiment;

FIG. 3 is a pictorial representation of a network of data processing systems in which illustrative embodiments may be implemented;

FIG. 4 is a block diagram of an information environment in accordance with an illustrative embodiment;

FIG. 5 is an illustration of two subgraphs with neighboring nodes allocated into groups in accordance with an illustrative embodiment;

FIG. 6 is an illustration of groups of neighboring nodes in accordance with an illustrative embodiment;

FIG. 7 is an illustration of clusters created from groups of neighboring entities in accordance with an illustrative embodiment;

FIG. 8 is an illustration of pieces of information in neighboring in accordance with an illustrative embodiment;

FIG. 9 is a flowchart of a process for managing information in accordance with an illustrative embodiment;

FIG. 10 is a flowchart of a process for matching center nodes in accordance with an illustrative embodiment;

FIG. 11 is a flowchart of a process for identifying groups of neighboring nodes in accordance with an illustrative embodiment;

FIG. 12 is a flowchart for creating a set of clusters in accordance with an illustrative embodiment;

FIG. 13 is a flowchart of a process for identifying best matching pairs of neighboring nodes in accordance with an illustrative embodiment;

FIG. 14 is a flowchart of a process for determining whether a first sub center node graph and a second center node match in accordance with an illustrative embodiment;

FIG. 15 is a flowchart of a process for determining whether a first center node and a second center node match in accordance with an illustrative embodiment;

FIG. 16 is a flowchart of a process for matching subgraphs in accordance with an illustrative embodiment;

FIG. 17 is a flowchart of a process for allocating neighboring nodes into groups in accordance with an illustrative embodiment;

FIG. 18 is a flowchart of a process for selecting a best matching node pair of neighboring nodes for each cluster in accordance with an illustrative embodiment;

FIG. 19 is a flowchart of a process for generating a feature vector in accordance with an illustrative embodiment;

FIG. 20 is a flowchart of a process for matching center nodes in accordance with an illustrative embodiment; and

FIG. 21 is a block diagram of a data processing system in accordance with an illustrative embodiment.

### DETAILED DESCRIPTION

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account a number of different considerations. For example, the illustrative embodiments recognize and take into account that current matching algorithms do not consider a relationship network of records with data represented as a graph. For example, the illustrative embodiments recognize and take into account that when comparing two records for a person, if the records have the same relationship to neighboring nodes in a graph, these records are likely to be for the same person. The illustrative embodiments recognize and take into account that comparing subgraphs can provide a stronger indication that the records are duplicates as compared to determining the similarity of names in the records themselves. Thus, the illustrative embodiments recognize and take into account that taking into account subgraph comparisons can improve matching results in a matching process.

Thus, the illustrative embodiments provide a method, apparatus, system, and computer program product for matching information. In one illustrative example, a first center node in a first subgraph and a second center node in a second subgraph are identified. Groups of neighboring nodes having the neighboring nodes from both the first subgraph and the second subgraph are identified by the computer system. A group of the neighboring nodes in the groups of the neighboring nodes has the neighboring nodes with a same node type. A set of clusters from each group of the neighboring nodes is created by the computer system such that each cluster in the set of clusters has the neighboring nodes from both the first subgraph and the second subgraph. A best matching node pair of the neighboring nodes in each cluster in the set of clusters is identified by the computer system to form a set of best matching node pairs in the set of clusters, wherein the neighboring nodes in the best matching node pair comprise a first node from the first subgraph and a second node from the second subgraph. Whether the first center node and second center node match is determined by the computer system based on an overall distance between the first center node and the second center node using the first center node, the second center node, and the best matching node pairs in the set of clusters.

As used herein, a “set of,” when used with reference to items, means one or more items. For example, a “set of clusters” is one or more clusters. Further, a “group of,” when used with reference to items, also means one or more items. For example, the “group of neighboring nodes” is one or more neighboring nodes.

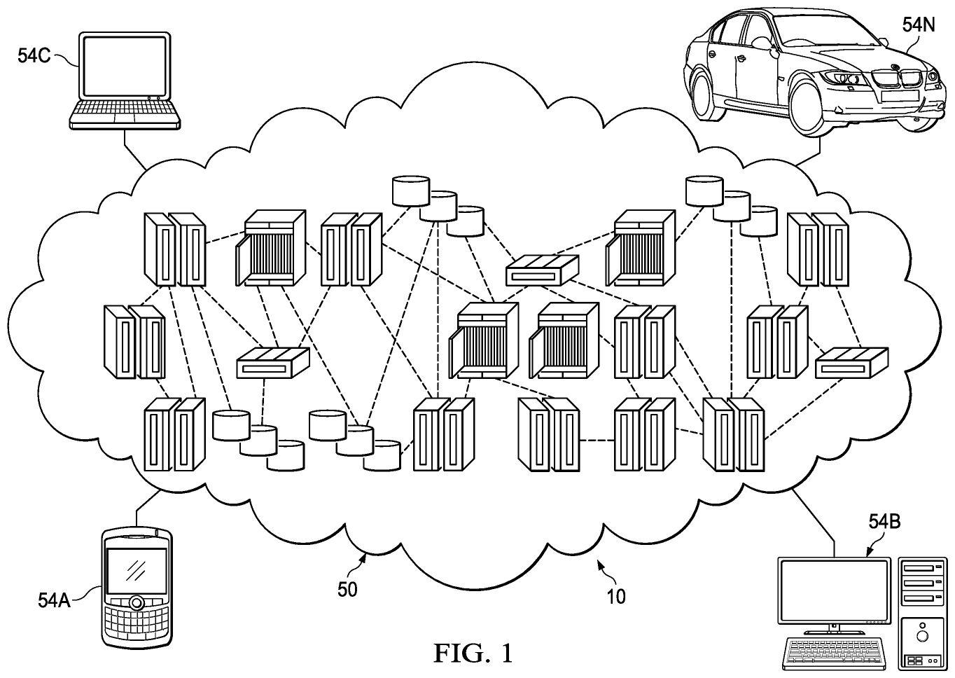

Referring now to FIG. 1, an illustration of cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 1 are intended to be illustrative only and that cloud computing nodes 10 in cloud computing environment 50 can communicate with any type of computerized device over any type of network and/or network addressable connection (e.g., using a web browser).

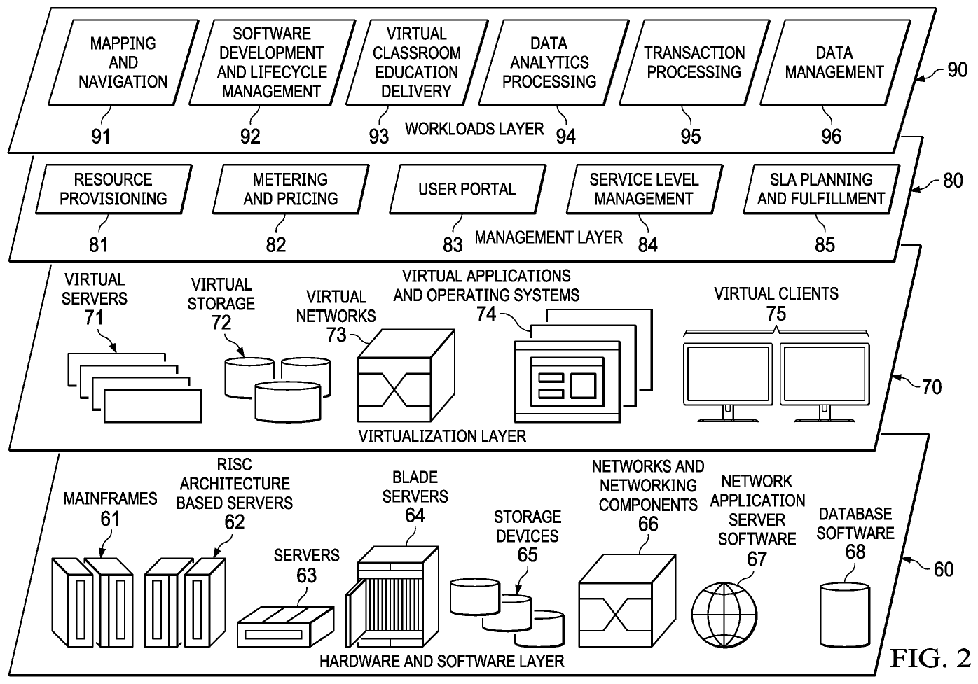

Referring now to FIG. 2, a set of functional abstraction layers provided by cloud computing environment 50 in FIG. 1 is shown. It should be understood in advance that the components, layers, and functions shown in FIG. 2 are intended to be illustrative only and embodiments of the invention are not limited thereto. As depicted, the following layers and corresponding functions are provided.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data management 96. Data management 96 provides a service for managing data in cloud computing environment 50 in FIG. 1 or a network in a physical location that accesses cloud computing environment 50 in FIG. 1.

For example, data management 96 can be implemented as a master data management service or in a data management service in which at least one of uniformity, accuracy, semantic consistency, or accountability can be increased in the management of information. This management of information by data management 96 can be useful when more than one copy of information is present. Data management 96 can maintain a single version of the truth across all copies of information. In one illustrative example, data management 96 can be used to manage information such as records located in multiple operation systems. In one illustrative example, data management 96 can identify duplicate records. Data management 96 can also reconcile duplicate records that have been identified. In the illustrative example, data management 96 can employ matching processes in processing information, such as records, to identify duplicate pieces of the information.

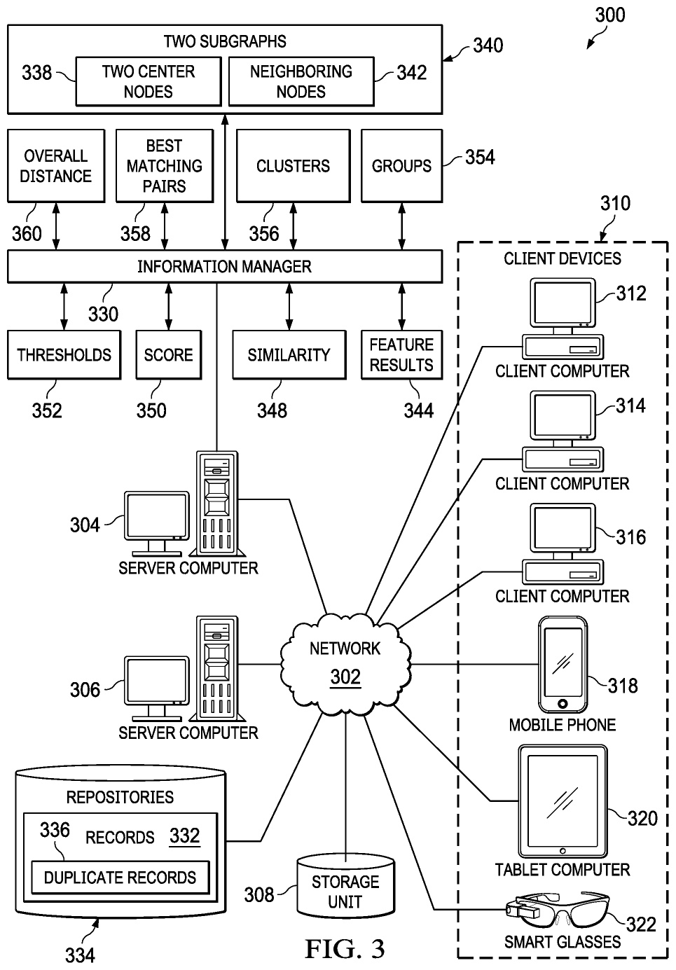

With reference now to FIG. 3, a pictorial representation of a network of data processing systems is depicted in which illustrative embodiments may be implemented. Network data processing system 300 is a network of computers in which the illustrative embodiments may be implemented. Network data processing system 300 contains network 302, which is the medium used to provide communications links between various devices and computers connected together within network data processing system 300. Network 302 may include connections, such as wire, wireless communication links, or fiber optic cables.

In the depicted example, server computer 304 and server computer 306 connect to network 302 along with storage unit 308. In addition, client devices 310 connect to network 302. As depicted, client devices 310 include client computer 312, client computer 314, and client computer 316. Client devices 310 can be, for example, computers, workstations, or network computers. In the depicted example, server computer 304 provides information, such as boot files, operating system images, and applications to client devices 310. Further, client devices 310 can also include other types of client devices such as mobile phone 318, tablet computer 320, and smart glasses 322. In this illustrative example, server computer 304, server computer 306, storage unit 308, and client devices 310 are network devices that connect to network 302 in which network 302 is the communications media for these network devices. Some or all of client devices 310 may form an Internet-of-things (IoT) in which these physical devices can connect to network 302 and exchange information with each other over network 302.

Client devices 310 are clients to server computer 304 in this example. Network data processing system 300 may include additional server computers, client computers, and other devices not shown. Client devices 310 connect to network 302 utilizing at least one of wired, optical fiber, or wireless connections.

Program code located in network data processing system 300 can be stored on a computer-recordable storage media and downloaded to a data processing system or other device for use. For example, program code can be stored on a computer-recordable storage media on server computer 304 and downloaded to client devices 310 over network 302 for use on client devices 310.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 300 also may be implemented using a number of different types of networks. For example, network 302 can be comprised of at least one of the Internet, an intranet, a local area network (LAN), a metropolitan area network (MAN), or a wide area network (WAN). FIG. 3 is intended as an example, and not as an architectural limitation for the different illustrative embodiments.

As used herein, a “number of,” when used with reference to items, means one or more items. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, information manager 330 is located in server computer 304. Information manager 330 can manage copies of information in the form of records 332 located in repositories 334. For example, information manager 330 can identify duplicate records 336 in records 332. In the depicted example, records 332 can be for objects selected from at least one of a person, a company, an organization, a supplier, an agency, a household, a product, a service, and other suitable types of objects.

When a match is identified in records 332, a reconciliation can be performed. This reconciliation can include removing duplicate copies of a record, merging records, or other suitable actions. In this illustrative example, duplicate records 336 may be an exact match or sufficiently match to represent the same object. In other words, a 100 percent match between two records may not be required in some examples for those two records to be a match and be designated as duplicate records 336.

For example, two records for people may be considered to be duplicate records 336 even though the names are not spelled exactly the same. For example, one record may be for “John Smith” while another record is for “Jon Smith.” Other information in the records may be sufficiently close such that the records are considered a match even though the names are not an exact match. As another example, “144 River Lane” and “144 River Ln.” can be considered a match for an address in a record.

In this illustrative example, the comparison of records 332 can be performed by information manager 330 using subgraphs. For example, information manager 330 can identify two center nodes 338 in two subgraphs 340 in which each of two center nodes 338 is in one of two subgraphs 340. As depicted, two subgraphs 340 also include neighboring nodes 342. Each of two subgraphs 340 can include a portion of neighboring nodes 342.

In this illustrative example, each neighboring node in neighboring nodes 342 can represent a record in records 332. For example, two center nodes 338 can each represent a record for a person. Neighboring nodes 342 can be records or other data structures representing objects that are connected or linked to two center nodes 338. The objects can be selected from at least one of a friend, an employer, a residence, a contract, a vehicle, a neighboring person, a relative, a business associate, a building, a work location, or some other suitable object that has a connection to one or more of two center nodes 338.

In this illustrative example, two subgraphs 340 are compared to determine whether a match is present between records 332 for two center nodes 338. In this illustrative example, identification of two center nodes 338 can be by information manager 330 made using any currently available matching techniques. Information of two center nodes 338 can be compared to generate feature results 344. Features are characteristics from the comparison of information in the center nodes.

For example, information can be derived from various fields in a record. For example, the information can be a name, a surname, a first name, a business address, a vehicle, a phone number, a ZIP Code, an area code, or some other information that can be in a record.

A feature can be characteristic in the comparison of the information. For example, a feature can be an exact match, a partial match, information missing, no match, or other types of features. These feature results 344 can be expressed as scores or numbers in a vector. These feature results 344 can also be used to identify candidate records for analysis by information manager 330. Feature results 344 can also be features based on the distance between two nodes, such as two center nodes 338.

In this example, feature results 344 can be used to determine which records in records 332 can be further processed by information manager 330. In other words, feature results 344 can be used to reduce the number of records that are compared when identifying duplicate records 336.

With the identification of two center nodes 338 in two subgraphs 340, information manager 330 can determine similarity 348 of two subgraphs 340 in determining whether records 332 represented by two center nodes 338 are duplicate records 336. In this illustrative example, similarity 348 can be based on the distance between two subgraphs 340 as described below. As a result, score 350 can be generated using similarity 348 or both similarity 348 and feature results 344 to determine whether two center nodes 338 represent duplicate records 336.

In this illustrative example, information manager 330 can make this determination by comparing score 350 against a number of thresholds 352. These thresholds can be upper-level thresholds or can define ranges for use in comparing score 350 to determine whether two center nodes 338 represent duplicate records 336.

Thus, information manager 330 can increase the accuracy in identifying duplicate records 336. Further, this accuracy can be increased in first order matching for an entity such as a person, an organization, an agency, or some other singular entity. Additionally, accuracy can also be increased in second order matching for entities such as a household. Determining similarity 348 of two center nodes 338 in two subgraphs 340 can have increased accuracy for second order matching when analyzing relationship information in two subgraphs 340.

As depicted, information manager 330 can use two center nodes 338 and neighboring nodes 342 in two subgraphs 340 for two center nodes 338 as inputs to determine similarity 348 of two center nodes 338. As depicted, information manager 330 allocates neighboring nodes 342 to groups 354. Each group in groups 354 represents a distinct node type. Each group in groups 354 has neighboring nodes 342 from both of two subgraphs 340. Clustering can be performed to determine clusters 356 within groups 354. In other words, each cluster of neighboring nodes 342 is the cluster of neighboring nodes 342 of the same type.

This clustering can be performed using any suitable clustering process. For example, density-based clustering can be performed on neighboring nodes 342 in a group from two subgraphs 340.

As depicted, each cluster in clusters 356 contains neighboring nodes 342 from both of two subgraphs 340. In other words, each cluster includes at least one neighboring node from each subgraph in two subgraphs 340.

Information manager 330 can identify a best matching node pair for each cluster in clusters 356 to form best matching node pairs 358. This determination can be made by determining a Hausdorrf distance in which a neighbor distance between two neighboring nodes from each subgraph in a cluster is computed. This neighbor distance can be based on comparing the neighboring nodes, the links for the neighboring being compared, and the index of the neighboring nodes being compared. The different distances can be used to determine overall distance 360 which can indicate similarity 348 between two center nodes 338. Overall distance 360 is the distance between two center nodes 338 that takes into account neighboring nodes 342. In other words, the distance between two center nodes 338 can change when taking into account neighboring nodes 342. In this example, neighboring nodes 342 are best matching node pairs for two center nodes 338. Overall distance 360 for two center nodes 338 can be used to determine whether records 332 for two center nodes 338 are similar enough to be considered duplicate records 336.

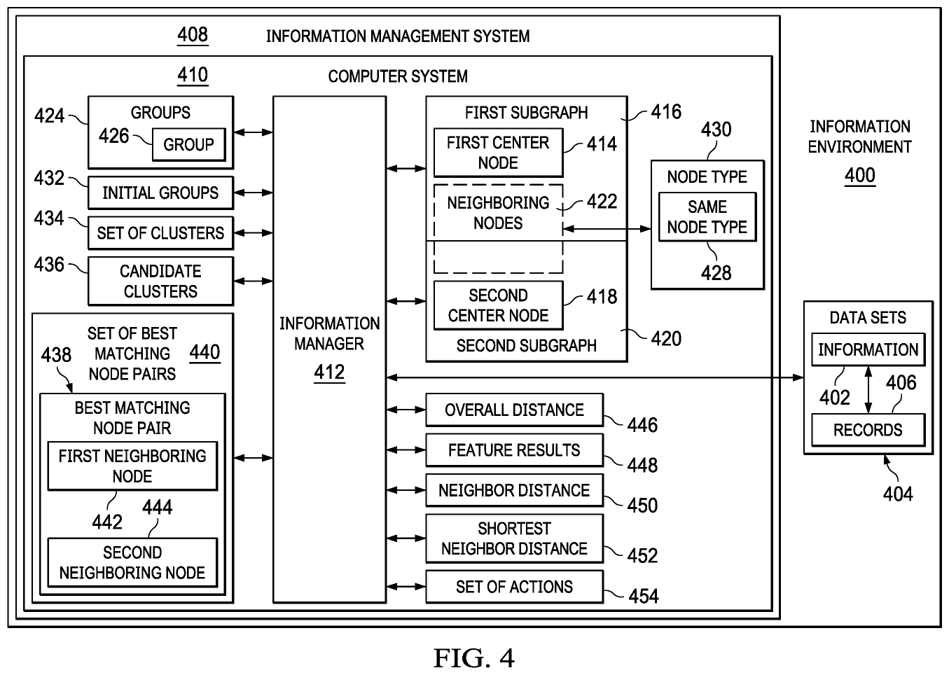

With reference now to FIG. 4, a block diagram of an information environment is depicted in accordance with an illustrative embodiment. In this illustrative example, information environment 400 includes components that can be implemented in hardware such as the hardware shown in network data processing system 300 in FIG. 3.

As depicted, information environment 400 is an environment in which information 402 can be managed. In this illustrative example, management of information 402 can include reconciling information 402 located in one or more of data sets 404. These data sets can be located in one or more repositories. These repositories can include, for example, at least one of a data warehouse, a data lake, a data mart, a database, or some other suitable data storage entity.

Information 402 can take various forms. For example, information 402 can take the form of records 406. A record in records 406 is a data structure used to organize information 402. For example, a record can be a collection of fields that may be of different data types. Records 406 can be stored in databases, tables, or other suitable constructs.

Information management system 408 in information environment 400 can operate to manage information 402. This management of information 402 can include storing, adding, removing, modifying, or performing other operations with respect to information 402. For example, information management system 408 can find duplicate information in one or more data sets 404. These duplicates can then be reconciled in which actions such as deduplication, merging duplicate information, or other actions can be performed.

In this illustrative example, information management system 408 comprises a number of different components. As depicted, information management system 408 includes computer system 410 and information manager 412.

Information manager 412 can be implemented in software, hardware, firmware, or a combination thereof. When software is used, the operations performed by information manager 412 can be implemented in program code configured to run on hardware, such as a processor unit. When firmware is used, the operations performed by information manager 412 can be implemented in program code and data and stored in persistent memory to run on a processor unit. When hardware is employed, the hardware may include circuits that operate to perform the operations in information manager 412.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 410 is a physical hardware system and includes one or more data processing systems. When more than one data processing system is present in computer system 410, those data processing systems are in communication with each other using a communications medium. The communications medium can be a network. The data processing systems can be selected from at least one of a computer, a server computer, a tablet computer, or some other suitable data processing system.

In this illustrative example, information manager 412 in computer system 410 identifies first center node 414 in first subgraph 416 and second center node 418 in second subgraph 420. This identification can be performed in a number of different ways. For example, currently available comparison algorithms used to compare pieces of information such as records 406 with each other can be used to identify first center node 414 and second center node 418 from information 402. These comparison algorithms include, for example, approximate string matching, record linkage, or other processes. In one illustrative example, each of these center nodes can be of record in records 406. This initial matching process can be used by information manager 412 to identify candidate center nodes for analysis.

Additionally, in this example, information manager 412 identifies first subgraph 416 and second subgraph 420. Neighboring nodes 422 in these two subgraphs are linked to one of first center node 414 and second center node 418.

As depicted, information manager 412 identifies groups 424 of neighboring nodes 422 having neighboring nodes 422 from both first subgraph 416 and second subgraph 420 with same node type 428 in node type 430. Node type 430 can be structural metadata and contain metadata for the different fields for pieces of information in a node. This metadata can include a field name, a data type, a granularity, and other information. For example, a node type can be a person, an organization, an agency, a vendor, a family household, a house, a vehicle, a contract, an insurance, a warranty, a service, or other suitable types of metadata.

In this illustrative example, a node is a collection of information for node type 430. A node can be, for example, a record or some other suitable piece of information 402.

In creating groups 424, information manager 412 can place neighboring nodes 422 from each subgraph into initial groups 432 based on node type 430 for neighboring nodes 422. Information manager 412 can select each initial group in initial groups 432 that have neighboring nodes 422 from both first subgraph 416 of neighboring nodes 422 and second subgraph 420 of neighboring nodes 422 to form groups 424 of neighboring nodes 422 having neighboring nodes 422 from both first subgraph 416 and second subgraph 420.

In this illustrative example, information manager 412 creates set of clusters 434 from each group of neighboring nodes 422 such that each cluster in set of clusters 434 has neighboring nodes 422 from both first subgraph 416 and second subgraph 420. In creating set of clusters 434, information manager 412 can create candidate clusters 436 within each group of neighboring nodes 422 in groups 424 of neighboring nodes 422. Information manager 412 can select each cluster in candidate clusters 436 that have neighboring nodes 422 from both first subgraph 416 of neighboring nodes 422 and second subgraph 420 of neighboring nodes 422 to form set of clusters 434.

In the illustrative example, information manager 412 identifies best matching node pair 438 of neighboring nodes 422 in each cluster in set of clusters 434 to form set of best matching node pairs 440 in set of clusters 434. The two neighboring nodes in best matching node pair 438 comprise first neighboring node 442 in neighboring nodes 422 from first subgraph 416 and second neighboring node 444 in neighboring nodes 422 from second subgraph 420.

In identifying best matching node pair 438, information manager 412 can determine neighbor distances 450 for neighboring nodes 422 being compared in a cluster. This comparison can be based on neighboring nodes 422 being compared, links for neighboring nodes 422 being compared, and depths for neighboring nodes 422 being compared. Information manager 412 can identify best matching node pair 438 for each cluster in set of clusters 434 as two nodes in the cluster having shortest neighbor distance 452 to form set of best matching node pairs 440 for set of clusters 434.

As depicted in this example, information manager 412 determines whether first center node 414 and second center node 418 match based on overall distance 446 between first center node 414 and second center node 418 using first center node 414, second center node 418, and set of best matching node pairs 440 in set of clusters 434.

Further, information manager 412 can use feature results 448 to identify candidate center nodes for analysis. If two center nodes are close enough to each other, additional steps can be performed to determine overall distance 446.

In this illustrative example, feature results 448 can include features regarding the comparison of information between first center node 414 and second center node 418. Feature results 448 can also include features based on a distance between first center node 414 and second center node 418. Feature results 448 can also be a total based on the sum of features obtained by comparing information between first center node 414 and second center node 418. In other words, a feature is a characteristic of interest that may be present in information being compared.

For example, the occurrence of a feature can be determined by comparing information such as a first name, a surname, a contract name, a vehicle manufacturer, a vehicle model, or other types of information between two center nodes. The feature can be, for example, an exact match, a partial match, a similar name, a name left out, a name unmatched, a number of exact words, a number of similar words, a number of left out words, a number of unmatched words, and other types of features that may be of interest. These types of features are comparison features. Feature results 448 can include at least one of individual scores for the different features or a total score based on all of the features. These scores can be organized in the form of a feature vector in which each element in the feature vector represents the occurrences of a particular feature. In one example, feature results 448 can be determined using currently available comparison algorithms used to identify first center node 414 and second center node 418.

If the two center nodes match, information manager 412 can perform set of actions 454 with respect to the pieces of information 402 for first center node 414 and second center node 418. Set of actions 454 includes, for example, deduplication, combining information 402, correcting information 402, or other suitable actions.

In one illustrative example, one or more technical solutions are present that overcome a technical problem with the amount of time and resources needed to match large numbers of records. As a result, one or more technical solutions may provide a technical effect of reducing at least one of the amount of time or resources needed to process information 402 to determine whether duplicate pieces of information 402 are present. In one illustrative example, one or more technical solutions are present that enable comparing subgraphs in a manner that provides a stronger indication of whether pieces of information, such as records represented as center nodes in the subgraphs, are duplicates as compared to determining the similarity of records themselves. In one illustrative example, one or more technical solutions are present in which subgraph comparisons are performed to improve the accuracy in results of matching records.

Computer system 410 can be configured to perform at least one of the steps, operations, or actions described in the different illustrative examples using software, hardware, firmware, or a combination thereof. As a result, computer system 410 operates as a special purpose computer system in which information manager 412 in computer system 410 enables determining whether pieces of information 402 match using at least one of less time or less resources as compared to current techniques. In particular, information manager 412 transforms computer system 410 into a special purpose computer system as compared to currently available general computer systems that do not have information manager 412.

In the illustrative example, the use of information manager 412 in computer system 410 integrates processes into a practical application for managing information 402 that increases the performance of computer system 410. In other words, information manager 412 in computer system 410 is directed to a practical application of processes integrated into information manager 412 in computer system 410 that determines whether a match is present between information using subgraph analysis. In this illustrative example, information manager 412 in computer system 410 can identify two center nodes and the subgraphs for the two center nodes and the neighboring nodes. Information manager 412 identifies groups of neighboring nodes of the two center nodes from both subgraphs based on a node type of the neighboring nodes. In other words, each group for a particular node type contains at least one neighboring node from each of the subgraphs. One or more clusters are identified by information manager 412 for neighboring nodes in each of the groups. In this illustrative example, each of these clusters includes at least one neighboring node from each of the two subgraphs. Information manager 412 identifies a best matching node pair of neighboring nodes for each cluster. This identification can be made by identifying the distance between pairs of nodes and selecting the node pair with the shortest distance as the best matching pair within a cluster. Information manager 412 can determine an overall distance between these two center nodes using the two center nodes and the best matching node pairs identified for the clusters. Information manager 412 can determine whether a match is present between the two center nodes based on overall distance 446 between the two center nodes. Overall distance 446 is the distance between first center node 414 and second center node 418 that takes into account neighboring nodes 442 such as the set of best matching node pairs 444 for first center node 414 and second center node 418.

In this manner, a determination is made as to whether two pieces of information such as two records corresponding to the two center nodes are a match. In this manner, information manager 412 in computer system 410 provides a practical application for matching information that the functioning of computer system 410 is improved. For example, by matching subgraphs, information manager 412 in computer system 410 can provide increased accuracy in determining whether a match is present between two pieces of information. In the illustrative example, information manager 412 can use overall distance 446 between the two center nodes to determine whether a match is present.

The illustration of information environment 400 in FIG. 4 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, although data sets 404 are shown as being located outside of computer system 410, one or more of data sets 404 can be located in computer system 410. Further, when computer system 410 includes multiple data processing systems, information manager 412 can be distributed and comprise components located in multiple data processing systems. In another example, first subgraph 416 may not include any of neighboring nodes 422 while second subgraph 420 contains all of neighboring nodes 422.

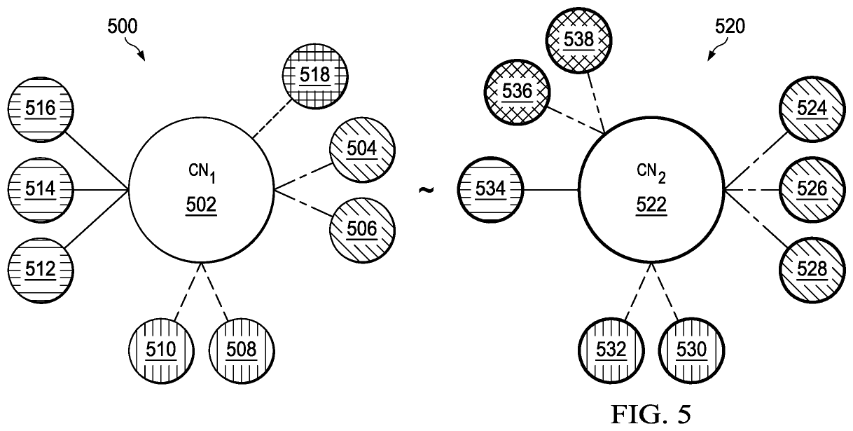

FIGS. 5-7 are illustrations of subgraphs that can be processed by information manager 412 in FIG. 4. With reference next to FIG. 5, an illustration of two subgraphs with neighboring nodes allocated into groups is depicted in accordance with an illustrative embodiment. In this illustrative example, first subgraph 500 comprises first center node CN1 502, neighboring node 504, neighboring node 506, neighboring node 508, neighboring node 510, neighboring node 512, neighboring node 514, neighboring node 516, and neighboring node 518. Second subgraph 520 comprises second center node CN2 522, neighboring node 524, neighboring node 526, neighboring node 528, neighboring node 530, neighboring node 532, neighboring node 534, neighboring node 536, and neighboring node 538. As depicted, each of the neighboring nodes has a node type. These two subgraphs are example implementations for first subgraph 416 and second subgraph 420 in FIG. 4.

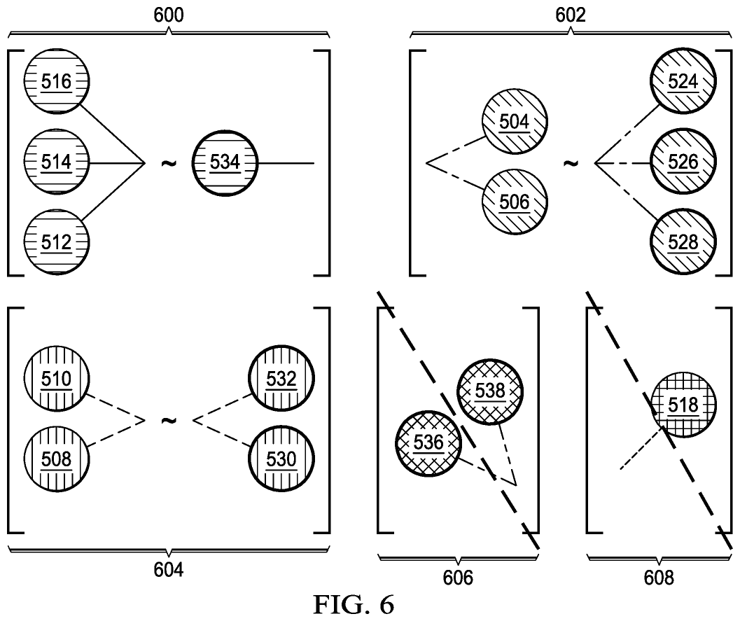

Turning now to FIG. 6, an illustration of groups of neighboring nodes is depicted in accordance with an illustrative embodiment. In the illustrative examples, the same reference numeral may be used in more than one figure. This reuse of a reference numeral in different figures represents the same element in the different figures.

As depicted in this figure, the neighboring entities in first subgraph 500 and second subgraph 520 are allocated or placed into groups based on node type. In other words, all of the neighboring nodes in a group are the same node type.

As depicted in this figure, group 600 comprises neighboring node 512, neighboring node 514, and neighboring node 516 from first subgraph 500 and neighboring node 534 from second subgraph 520. Group 602 comprises neighboring node 504 and neighboring node 506 from first subgraph 500 and neighboring node 524, neighboring node 526, and neighboring node 528 from second subgraph 520. Group 604 comprises neighboring node 508 and neighboring node 510 from first subgraph 500 and neighboring node 530 and neighboring node 532 from second subgraph 520.

In this illustrative example, group 606 comprises neighboring node 536 and neighboring node 538 from second subgraph 520. Group 606 does not include any neighboring nodes from first subgraph 500. Group 608 comprises neighboring node 518 from first subgraph 500. This group does not include any neighboring nodes from second subgraph 520.

The groups are selected from groups in which neighboring nodes are present from both subgraphs. In this example, the groups comprise group 600, group 602, and group 604. Group 606 and group 608 are not included in the groups for further processing. These groups do not include neighboring nodes from both subgraphs. As a result, comparisons for distance or features between different subgraphs cannot be made using these groups.

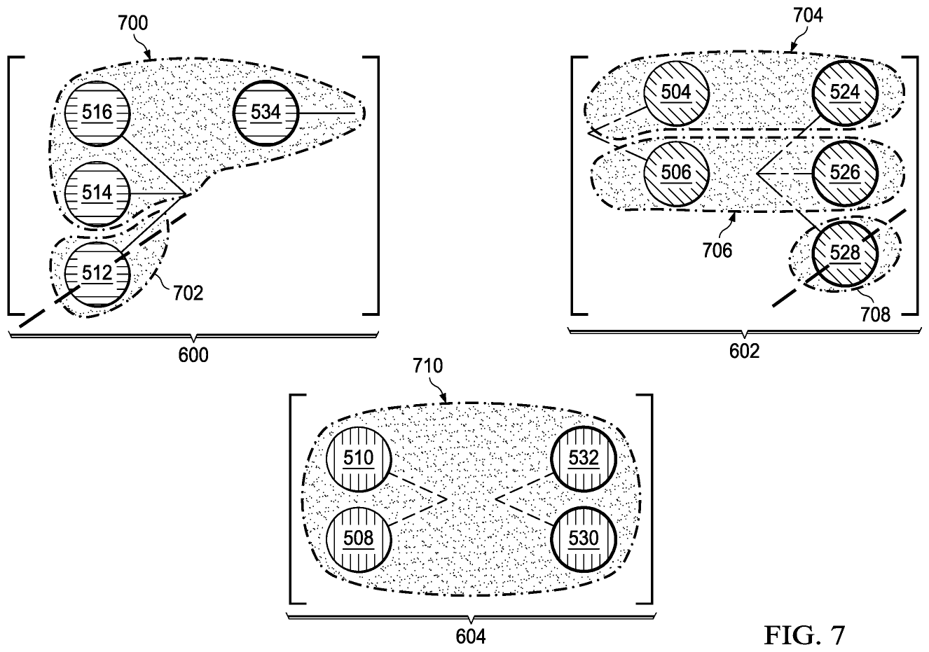

Turning next to FIG. 7, an illustration of clusters created from groups of neighboring entities is depicted in accordance with an illustrative embodiment. In this illustrative example, clusters are created from each group of neighboring nodes in which neighboring nodes are present from both subgraphs in a group. The clustering is performed to group neighboring nodes such that the neighboring nodes in a cluster of neighboring nodes are more similar to each other than the neighboring nodes in other clusters.

This clustering can be formed using an algorithm or a machine learning model implemented clustering. The clustering can be performed using various clustering techniques. For example, density-based spatial clustering of applications with noise (BDSCAN), k-means clustering, distribution-based clustering, density-based clustering, or other types of clustering can be used.

As depicted, the clustering results in the creation of cluster 700 and cluster 702 in group 600; cluster 704, cluster 706, and cluster 708 in group 602; and cluster 710 in group 604. In this illustrative example, the clusters selected for further processing of clusters are clusters that include neighboring nodes from both subgraphs. As depicted, cluster 702 and cluster 708 are removed because these clusters only include nodes from one of the two subgraphs. The outcome of clustering can be one or more clusters in which each cluster holds one set of neighboring nodes of the same type from each of the subgraphs. In this example, four clusters remain in which these clusters contain neighboring nodes of the same type from each of the subgraphs.

From these clusters, best matching node pairs can be determined. A best matching node pair can be determined for each of the clusters that contain neighboring nodes from both of the subgraphs. The best matching node pair in a cluster is a pair of nodes from the different subgraphs having the shortest distance. In other words, a best matching node pair comprises a first neighboring node from first subgraph 500 and a second neighboring node from second subgraph 520 in which those two neighboring nodes have the shortest distance between them in the cluster as compared to other pairs of neighboring nodes in the cluster.

For example, when the distance between neighboring node 516 and neighboring node 534 is 0.1 and the distance between neighboring node 514 and neighboring node 534 is 0.6 in cluster 700, the best matching the pair is neighboring node 516 and neighboring node 534.

As another example, in cluster 704, the best matching node pair is neighboring node 504 and neighboring node 524. These are the only two nodes in the cluster. Neighboring node 506 and neighboring node 526 are the best matching node pair in cluster 706.

In cluster 710, the distance between neighboring node 510 and neighboring node 532 is 0.2; the distance between neighboring node 510 and neighboring node 530 is 0.3; the distance between neighboring node 508 and neighboring node 532 is 0.6; and the distance between neighboring node 508 and neighboring node 530 is 0.4. In this example, the best matching node pair in cluster 710 comprises neighboring node 510 and neighboring node 532. As can be seen, the distances are calculated between node pairs in which each node pair comprises a neighboring node from each of the two subgraphs.

These minimum distances identified can be a Hausdorff distance that is applied to the different subsets of nodes clusters. In mathematics, the Hausdorff distance measures how far two subsets of a metric space are from each other. The Hausdorff distance is also referred to as the Hausdorff metric. For example, the Hausdorff distance for cluster 700 can be dH=min(0.1, 0.6)=0.1. The Hausdorff distance for cluster 704 is dH=min(0.2)=0.2 and for cluster 706 is dH=min(0.5)=0.5. The Hausdorff distance for cluster 710 is dH=min(0.2, 0.3, 0.6, and 0.4)=0.2.

As a result, the collection of the Hausdorff distances is [0.1, 0.2, 0.5, 0.2] in which each of these values is the minimum value for the best matching node pairs in the clusters identified for the groups from first subgraph 500 and second subgraph 520.

In this illustrative example, a distance feature vector based on distance for the neighboring nodes can be determined based on counts of distances that are within various thresholds or ranges. For example, the distance feature vector can be determined as follows: feature vector fv(i)=[count of dHs<0.3, count of 0.7>dHs>0.3, count of dHs]. As a result, the feature vector in this example is fv(i)=[3, 1, 0].

A comparison feature vector can be determined from comparing information in the center nodes. For example, if first center node 502 is [John Smith Jr.] and second center node 522 is [Johnny Smith], features can be identified based on the comparison of information between these two center nodes. The features based on comparison of information can be, for example, [name_exact, name_similar, name_leftout, name_unmatched]. In this example, the comparison feature vector for the center nodes is fv(i)=[1, 1, 1, 0]. In this specific example, the first 1 is the count of [Smith vs. Smith], the second 1 is the count of [John vs. Johnny], and the third 1 is the count of [Jr. vs. none].

As a result, the overall feature vector containing comparison features of the center nodes and distance features neighboring results is fv(i)=[1, 1, 1, 0, 3, 1, 0]. This feature vector can be used in determining the similarity of first subgraph 500 and second subgraph 520 in which the similarity takes into account first center node 502, second center node 522, and the best matching node pairs.

In this example, the similarity can be measured by the overall distance between first center node 502 and second center node 522. In this particular example, with a feature vector of fv and coefficient vector of cv, the distance can be computed as:

$$distance = \frac{max ( c v ) - ( {Σ}_{i = 0}^{n} c v ( i ) * f v ( i ) ) / ( {Σ}_{i = 0}^{n} f v ( i ) )}{max ( c v ) - min ( c v )}$$

where cv(i) is a coefficient vector, fv(i) is a feature vector comprising the comparison features and the distance features, max(cv) is an element in the coefficient vector with a maximum value, min(cv) is the element in the coefficient vector with a minimum value, i is an index value, and n is a number of elements in the feature vector.

In this example, this feature vector comprising comparison features from the comparison feature vector and distance features from the distance feature vector can be used to determine the overall distance between first center node 502 and second center node 522. Further, weighting can be applied to the different feature vectors using feature vector coefficients. These coefficients can be predetermined. The coefficients can be determined using a subject matter expert or a machine learning model. For example, higher feature vector coefficients can be used for particular elements in the feature vector that are to be given more importance in determining the similarity of the two center nodes.

In the example depicted in FIGS. 5-7, for a feature vector of [1, 1, 1, 0, 3, 1, 0] and a coefficient vector of [10, 7, −5, −10, 5, 2, 0.5], the overall distance between first center node and second center node can be determined as:

$$overall distance = \frac{\begin{matrix}10 ( ( 10 * 1 + 7 * 1 + ( - 5 ) * 1 + ( - 10 ) * 0 + 5 * 3 + 2 * 1 + 0.5 * 0 ) / \\ ( 1 + 1 + 1 + 0 + 3 + 1 + 0 )\end{matrix}}{10 - ( - 10 )} = 0.293$$

which is a more accurate distance, compared to the case where these two center nodes were compared without taking into account neighboring nodes in their subgraphs:

$$overall distance = \frac{\begin{matrix}10 - ( ( 10 * 1 + 7 * 1 + ( - 5 ) * 1 + ( - 10 ) * 0 ) / \\ ( 1 + 1 + 1 + 0 )\end{matrix}}{10 - ( - 10 )} = 0.3$$

In this depicted example, comparing subgraphs for center nodes provides increased accuracy and granularity in determining the similarity between records or information for the center nodes as compared to only comparing records for the center nodes. In other words, the comparison of the subgraphs can be performed by determining the distance between the center nodes and adjusting the determined distance between the center nodes based on the neighboring nodes in the subgraphs in which the adjusted distance is an overall distance for the two center nodes.

The illustrations of the two center nodes and neighboring nodes for the two subgraphs in FIGS. 5-7 are presented for purposes of illustrating one manner in which different operations can be performed on subgraphs in an illustrative example and not meant to limit the manner in which other illustrative examples can be implemented. For example, eight neighboring nodes are shown for each graph. In other illustrative examples, other numbers of neighboring nodes can be present. For example, 3, 25, 300, or some other number of neighboring nodes can be present in each subgraph. One subgraph may not have the same number of neighboring nodes as the other subgraph then analyzed. As another example, the neighboring nodes are shown as only having a depth of one from the center node. In other illustrative examples, neighboring nodes may have other depths such as 2, 3, 6, or some other depth in the subgraph. For example, a particular neighboring node may have a depth of 2 from a center node. In other words, the particular neighboring node may have a link to another neighboring node that is linked to the center node. In another illustrative example, the feature vector may only include distance features of the distance feature vector for the neighboring nodes.

In another illustrative example, a feature vector can be generated from comparison features and distance features directly without having to generate a comparison feature vector and the distance feature vector. In some illustrative examples, the feature vector can include distance features without the comparison features. In yet another illustrative example, a feature vector can be generated from comparison of the two center nodes in which the feature vector includes both comparison features and distance features. The distance features, in this example, are based on a distance calculated between the two center nodes.

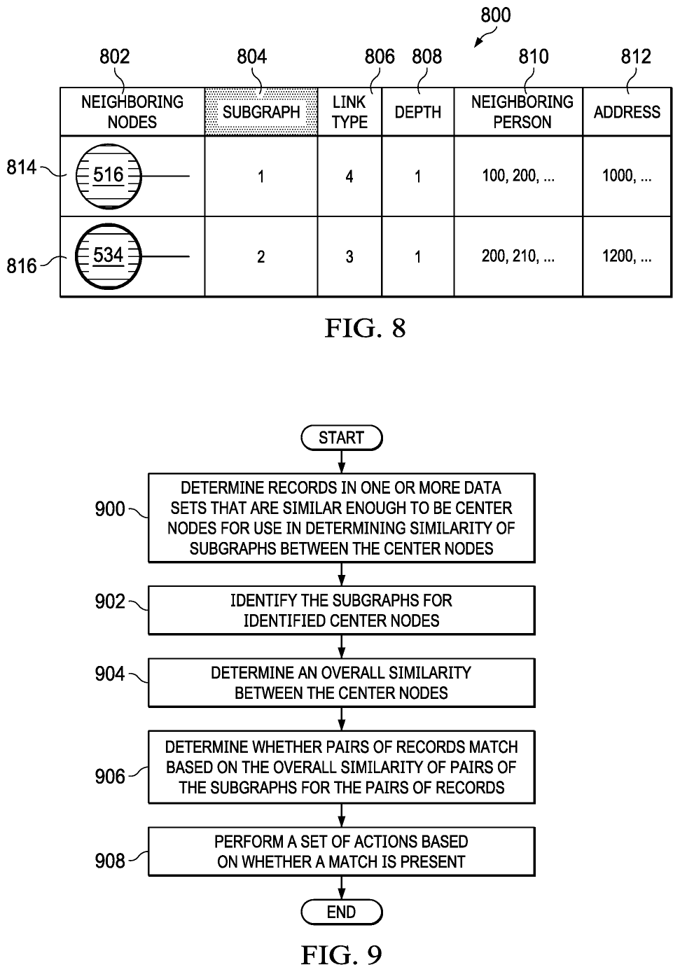

With reference next to FIG. 8, an illustration of pieces of information in neighboring nodes is depicted in accordance with an illustrative embodiment. In this illustrative example, table 800 illustrates information that may be present for neighboring nodes.

As depicted, table 800 includes a number of different columns. In this example, these columns include neighboring node 516 and neighboring node 534 which are the same node type in this example.

In this illustrative example, table 800 has a number of different columns identifying information for neighboring nodes. These columns include neighboring nodes 802, subgraph 804, link type 806, depth 808, neighboring person 810, and address 812.

Neighboring node 802 is an identifier of the neighboring node. In this example, the neighboring node in row 814 corresponds to neighboring node 516 and the neighboring node in row 816 corresponds to neighboring node 534.

Subgraph 804 identifies the subgraph that a neighbor neighboring belongs to in this example. Link type 806 is an identifier of a particular type of link that connects the neighboring node to another node. The other node can be another neighboring node or a center node. The values in link type 806 indicate what type of structural metadata containing information for the relationship between two neighboring node types is present. In this illustrative example, link type 806 indicates link to a node of neighboring person. Depth 808 identifies the number of links that connect the neighboring node to the center node. In this example, the depth is 1 for both neighboring nodes.

In this illustrative example, neighboring person 810 is a type of bucket group. The hash values in neighboring person 810 are hash values generated from hashing the name of the neighboring person. Address 812 is a bucket for an address of the neighboring person identified in neighboring person 810. The hash values in address 812 are generated from hashing the address for each neighboring person. Other examples of categories for buckets include phone number, business address, vehicle model, city, country, or other suitable categories.

In this illustrative example, hashes can be generated for a field or attribute. The different actions can be generated to take into account known or acceptable variations for a particular category such as a name. In this manner, partial matches can be identified to take into account of data entry errors. This type of multiple bucket hash generation for a single attribute can be applied to data such as a phone number, a birthdate, or other suitable information.

The depiction of table 800 is of limited types of data for purposes of illustrating different features in one illustrative example. Implementations of illustrative examples can have many more buckets or other information in neighboring nodes. Additionally, a bucket may include more than one category. For example, a bucket may be a name and an area code. As another example, a bucket can be a contract, Jones, and Seattle.

Turning next to FIG. 9, a flowchart of a process for managing information is depicted in accordance with an illustrative embodiment. The process in FIG. 9 can be implemented in hardware, software, or both. When implemented in software, the process can take the form of program code that is run by one or more processor units located in one or more hardware devices in one or more computer systems. This process can be implemented in data management 96 in FIG. 2. In the illustrative example, the process can be implemented in information manager 330 in network data processing system 300 in FIG. 3 and in information manager 412 in computer system 410 in FIG. 4. This process can be used to manage pieces of information. In this example, the pieces of information take the form of records, but can take other forms in the particular implementation.

The process begins by determining records in one or more data sets that are similar enough to be center nodes for use in determining similarity of subgraphs between the center nodes (step 900). In step 900, comparisons can be made between the records to obtain feature results, such as feature results 448 in FIG. 4. The results of these comparisons can be used to identify which center nodes are close enough or similar enough to each other to warrant further processing. In other words, step 900 can be performed as an initial pass in identifying candidate center nodes from the records. These comparisons do not take into account neighboring nodes in the subgraphs in this example. For example, a distance can be determined between center nodes based only on the center nodes themselves.

In step 900, the identification of a match between the center nodes can reduce the number of comparisons that are made. As a result, a detailed comparison of the subgraphs for a center node with the subgraphs for every other center node does not need to be made.

Once two center nodes are identified as being sufficiently similar for further processing, comparing the similarity of the contextual and independent networks of the two center nodes can increase or decrease the overall confidence in concluding whether the two center nodes are similar or different. These different networks are subgraphs for the two center nodes.

The process identifies the subgraphs for identified center nodes (step 902). The process determines an overall similarity between the center nodes (step 904). In step 904, the process can determine an overall similarity between the center node by taking into account the center nodes and neighboring nodes within the subgraphs for the center nodes. For example, comparing two center nodes of “John Smith,” which themselves could be somewhat similar. If the first center node is only related to an entity “ABC Company in Canada” with employment relationship and the second center node is only related to “XYZ” with partnership relationship, then an interpretation can be made that the center nodes are less-likely similar. However, if the second center node has an additional employment relationship to “ABC Company,” which may or may not be a different node from “ABC Company in Canada” related to the first node, then the situation can lead to conclude the two center nodes are more-likely similar.

The process determines whether pairs of records match based on the overall similarity of pairs of the subgraphs for the pairs of records (step 906). In this illustrative example, the determination can also include an analysis of the feature results determined by the initial analysis of records to identify the center nodes. In step 906, the records can be center nodes.

The process then performs a set of actions based on whether a match is present (step 908). The process terminates thereafter. In step 908, the actions can include at least one of deduplication, merging matching records, or other suitable actions can be performed. In this manner, consistency between information in different data sets can be obtained to perform operations such as reporting, transactions, or other suitable operations that require at least one of accuracy or consistency in records found in one or more data sets.

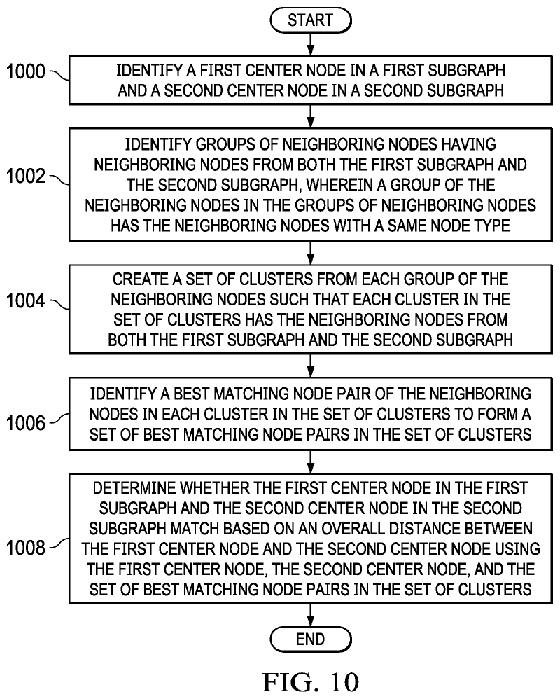

Turning next to FIG. 10, a flowchart of a process for matching center nodes is depicted in accordance with an illustrative embodiment. The process in FIG. 10 can be implemented in hardware, software, or both. When implemented in software, the process can take the form of program code that is run by one or more processor units located in one or more hardware devices in one or more computer systems. This process can be implemented in data management 96 in FIG. 2. In the illustrative example, the process can be implemented in information manager 330 in network data processing system 300 in FIG. 3 or information manager 412 in computer system 410 in FIG. 4. The process in this step can be used to implement step 908 in FIG. 9.

The process begins by identifying a first center node in a first subgraph and a second center node in a second subgraph (step 1000). The process identifies groups of neighboring nodes having neighboring nodes from both the first subgraph and the second subgraph, wherein a group of the neighboring nodes in the groups of neighboring nodes has the neighboring nodes with a same node type (step 1002).

The process creates a set of clusters from each group of the neighboring nodes such that each cluster in the set of clusters has the neighboring nodes from both the first subgraph and the second subgraph (step 1004). The process identifies a best matching node pair of the neighboring nodes in each cluster in the set of clusters to form a set of best matching node pairs in the set of clusters (step 1006). In step 1006, the neighboring nodes in the best matching node pair comprise a first neighboring node from the first subgraph and a second neighboring node from the second subgraph.

The process determines whether the first center node in the first subgraph and the second center node in the second subgraph match based on an overall distance between the first center node and the second center node using the first center node, the second center node, and the set of best matching node pairs in the set of clusters (step 1008). In step 1008, the overall distance is different from the distance between the two center nodes without taking into account the neighboring nodes in the subgraphs. The process terminates thereafter.

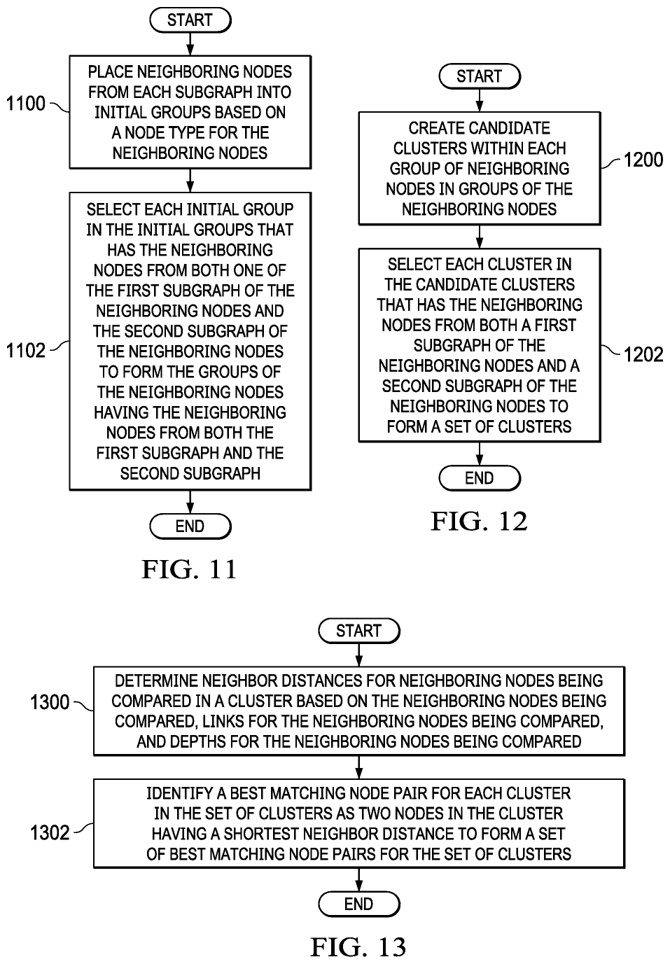

With reference to FIG. 11, a flowchart of a process for identifying groups of neighboring nodes is depicted in accordance with an illustrative embodiment. The process in this figure is an example of one implementation for step 1002 in FIG. 10.

The process begins by placing neighboring nodes from each subgraph into initial groups based on a node type for the neighboring nodes (step 1100). The process selects each initial group in the initial groups that has the neighboring nodes from both one of the first subgraph of the neighboring nodes and the second subgraph of the neighboring nodes to form the groups of the neighboring nodes having the neighboring nodes from both the first subgraph and the second subgraph (step 1102). The process terminates thereafter.

Turning to FIG. 12, a flowchart for creating a set of clusters is depicted in accordance with an illustrative embodiment. The process in this figure is an example of one implementation for step 1004 in FIG. 10.

The process begins by creating candidate clusters within each group of neighboring nodes in groups of the neighboring nodes (step 1200). The process selects each cluster in the candidate clusters that has neighboring nodes from both a first subgraph of the neighboring nodes and a second subgraph of the neighboring nodes to form a set of clusters (step 1202). The process terminates thereafter.

With reference to FIG. 13, a flowchart of a process for identifying best matching pairs of neighboring nodes is depicted in accordance with an illustrative embodiment. The process in this figure is an example of one implementation for step 1006 in FIG. 10.

The process begins by determining neighbor distances for neighboring nodes being compared in a cluster based on the neighboring nodes being compared, links for the neighboring nodes being compared, and depths for the neighboring nodes being compared (step 1300). In step 1300, the neighbor distances can be determined in a number of different ways. For example, Breadth-first search, Dijkstra's algorithm, or Bellman-Ford algorithm are examples of algorithms that can be used to determine these distances.

In this example, the neighbor distances for the neighboring nodes in the cluster based on the neighboring nodes being compared, the links for the neighboring nodes being compared, and the depths for the neighboring nodes being compared are calculated using one of the following equations:

d(x,y)=e^{(log(1-distance(x,y))+log(1-distance(link(X),link(Y)))+log(const}^{^{depth(x,y)}}⁾⁾

where distance(x,y) is a distance between a node x and a node y in a cluster, depth(x,y) is an average depth of a first depth for the node x and a second depth for the node y, and const is a constant value greater than 0 and less than or equal to 1. A depth for a node x is the count of links having the shortest path from the node to the center node for node x. In this example, depth(x,y) also can be an average of (1) the number of shortest links between node X and the first center node, and (2) the number of shortest links between node Y and the second center node.

d(x,y)=1((1−distance(x,y))*(1−distance(linkₓ,linkY))*Const^{depth(x,y)})

where distance(x,y) is the distance between a node x and a node y in a cluster, depth(x,y) is an average depth of a first depth for the node x and a second depth for the node y, and const is a constant value that is greater than 0 and less than or equal to 1. A depth for a node x is the count of links having the shortest path from the node to the center node for node x.

The process identifies a best matching node pair for each cluster in the set of clusters as two nodes in the cluster having a shortest neighbor distance to form a set of best matching node pairs for the set of clusters (step 1302). The process terminates thereafter.

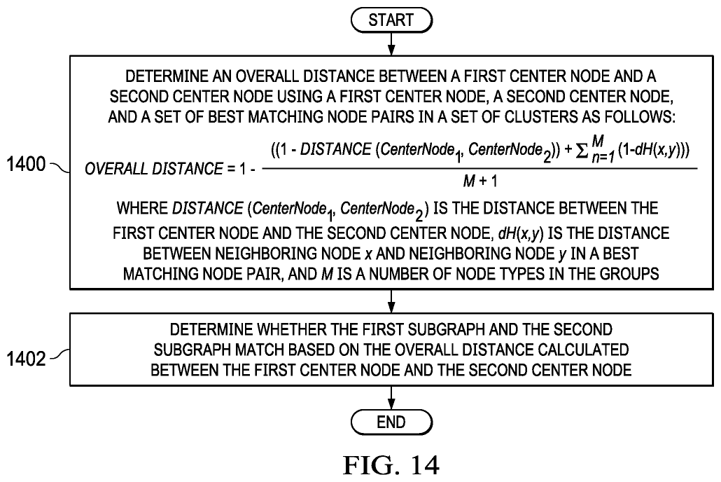

In FIG. 14, a flowchart of a process for determining whether a first center node and a second center node match is depicted in accordance with an illustrative embodiment. The process in this figure is an example of one implementation for step 1008 in FIG. 10.

The process begins by determining an overall distance between a first center node and a second center node using a first center node, a second center node, and a set of best matching node pairs in a set of clusters as follows:

$$overall distance = 1 - \frac{( \begin{matrix}( 1 - distance ( {CenterNode}_{1} , {CenterNode}_{2} ) ) + \\ {\sum }_{n = 1}^{M} ( 1 - dH ( x , y ) )\end{matrix} )}{M + 1}$$

where distance(CenterNode₁, CenterNode₂) is the distance between the first center node and the second center node, dH(x,y) is the distance between neighboring node x and neighboring node y in a best matching node pair, and M is a number of node types with a best matching neighboring node pair in the groups (step 1400). In this illustrative example, distance represented by dH(x,y) is a value between 0 to 1. Also, distance(CenterNode₁, CenterNode₂) is a value between 0 and 1. As a result, overall distance is a value between 0 and 1 in this illustrative example. In this example, a value of 0 means an exact match is present between the data being compared and a value of 1 means that the data being compared are totally different. In some cases, some neighbor-nodes of a given node type may exist in the first subgraph, while no neighbor node of same node type exists in the second subgraph. These node types without matches between the two subgraphs are not included in M.

In this example, neighboring node x can be connected by CenterNode₁ and neighboring node y can be connected to CenterNode₂. This connection can be direct or indirect with intervening nodes. In this example, dH(x,y) is a minimum distance that can be determined for different combinations of neighboring nodes, neighboring node x and neighboring node x, in a cluster.

The process determines whether the first subgraph and the second subgraph match based on the overall distance calculated between the first center node and the second center node (step 1402). The process terminates thereafter.

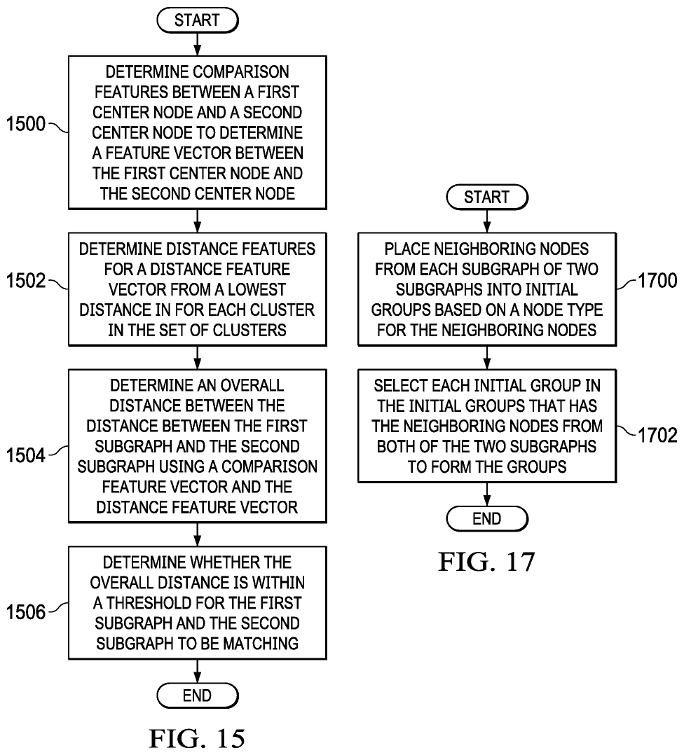

Turning now to FIG. 15, a flowchart of a process for determining whether a first center node and a second center node match is depicted in accordance with an illustrative embodiment. The process in this figure is an example of one implementation for step 1008 in FIG. 10.

The process begins by determining comparison features between a first center node and a second center node for a comparison feature vector for the first center node and the second center node (step 1500). A feature is a characteristic of interest between the information being compared. This type of feature is a comparison feature. For example, in comparing the names in the center node, the features of interest for the comparison of names can be [number of exact words, number of similar words, number of left out words, number of unmatched words]. In comparing “John Smith Jr.” with “Johnny Smith” for these features, a count of 1 is present for the elements of the comparison feature vector for the number of exact words [Smith, Smith]. The second feature, the number of similar words, is present with [John, Johnny]. The third feature, the number of left out words, is present with respect to discerning [Jr., none]. The fourth feature of the number of unmatched words is 0 because matches are present. As a result, the comparison feature vector in this example is fv=[1, 1, 1, 0].

The process determines a distance feature from a lowest distance for each cluster in the set of clusters (step 1502). In this example, a distance feature can be based on whether a particular distance is within a threshold range specified for the distance feature. For example, distance features can be [distance_less_than_0.3, distance_between_0.3_0.7, and distance_larger_than_0.7]. In this example, three distance features are present and the distance feature vector indicates a count of how many nodes are present for each of the particular features.

The process determines an overall distance between the distance between the first center node and the second center node using a comparison feature vector and the distance feature vector (step 1504). In step 1504, the comparison feature vector is for the center nodes and the distance feature vector as determined for the neighboring node. In step 1504, the overall distance between two center nodes taking into account their neighboring nodes in form of the best matching node pairs is determined as follows:

$$overall distance = \frac{max ( c v ) - ( {Σ}_{i = 0}^{n} c v ( i ) * f v ( i ) ) / ( {Σ}_{i = 0}^{n} f v ( i ) )}{max ( c v ) - min ( c v )}$$

where cv(i) is the element at index i of the coefficient vector, fv(i) is the element at index i of the feature vector, comprising the comparison feature vector and the distance feature vector, max(cv) is an element in the coefficient vector with a maximum value, min(cv) is the element in the coefficient vector with a minimum value, i is an index value, and n is a number of elements in the feature vector. In this particular example, the feature vector fv includes both the comparison features for the center nodes and the distance features for the clusters.

The feature vector in this example contains elements for comparison features in the center nodes and a distance feature for neighboring nodes. The coefficient vector comprises elements that are used in applying weights to corresponding features in the feature vector. These coefficient vectors can be used to show the importance of each feature in the feature vector to the overall computation. The coefficient vectors can be predetermined or generated using a machine learning model.

The process determines whether the overall distance is within a threshold for the first center node and the second center node to be matching (step 1506). The process terminates thereafter.

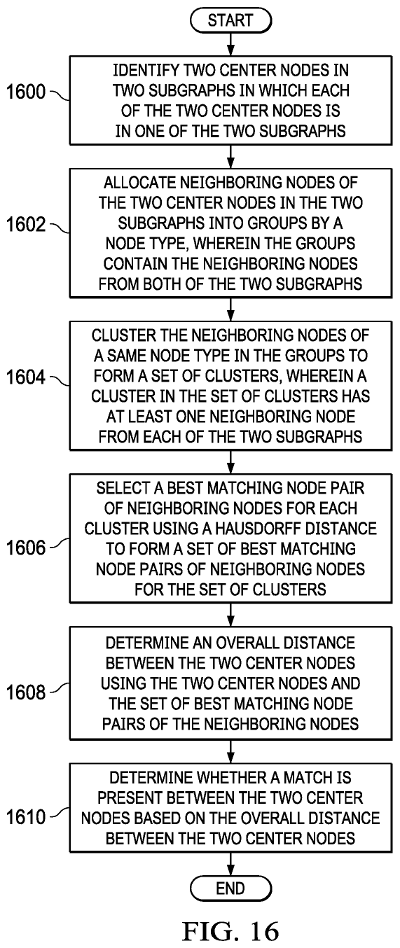

With reference now to FIG. 16, a flowchart of a process for matching subgraphs is depicted in accordance with an illustrative embodiment. The process in FIG. 16 can be implemented in hardware, software, or both. When implemented in software, the process can take the form of program code that is run by one or more processor units located in one or more hardware devices in one or more computer systems. This process can be implemented in data management 96 in FIG. 2. In the illustrative example, the process can be implemented in information manager 330 in network data processing system 300 in FIG. 3 and information manager 412 in computer system 410 in FIG. 4. The process in this step can be used to implement step 908 in FIG. 9.

The process begins by identifying two center nodes in two subgraphs in which each of the two center nodes is in one of the two subgraphs (step 1600). The process allocates neighboring nodes of the two center nodes in the two subgraphs into groups by a node type, wherein the groups contain the neighboring nodes from both of the two subgraphs (step 1602). The process clusters the neighboring nodes of a same node type in the groups to form a set of clusters, wherein a cluster in the set of clusters has at least one neighboring node from each of the two subgraphs (step 1604).

The process selects a best matching node pair of neighboring nodes for each cluster using a Hausdorff distance to form a set of best matching node pairs of neighboring nodes for the set of clusters (step 1606). In this example, a best matching node pair in the set of best matching node pairs has a neighboring node from each of the two subgraphs.

The process determines an overall distance between the two center nodes using the two center nodes and the set of best matching node pairs of the neighboring nodes (step 1608). In step 1608, the overall distance between the two center nodes takes into account the set of best matching node pairs for the two center nodes. The process determines whether a match is present between the two center nodes based on the overall distance between the two center nodes (step 1610). The process terminates thereafter.

In FIG. 17, a flowchart of a process for allocating neighboring nodes into groups is depicted in accordance with an illustrative embodiment. The process in this figure is an example of one implementation for step 1602 in FIG. 16.

The process begins by placing neighboring nodes from each subgraph of two subgraphs into initial groups based on a node type for the neighboring nodes (step 1700). The process selects each initial group in the initial groups that has the neighboring nodes from both of the two subgraphs to form the groups (step 1702). The process terminates thereafter.

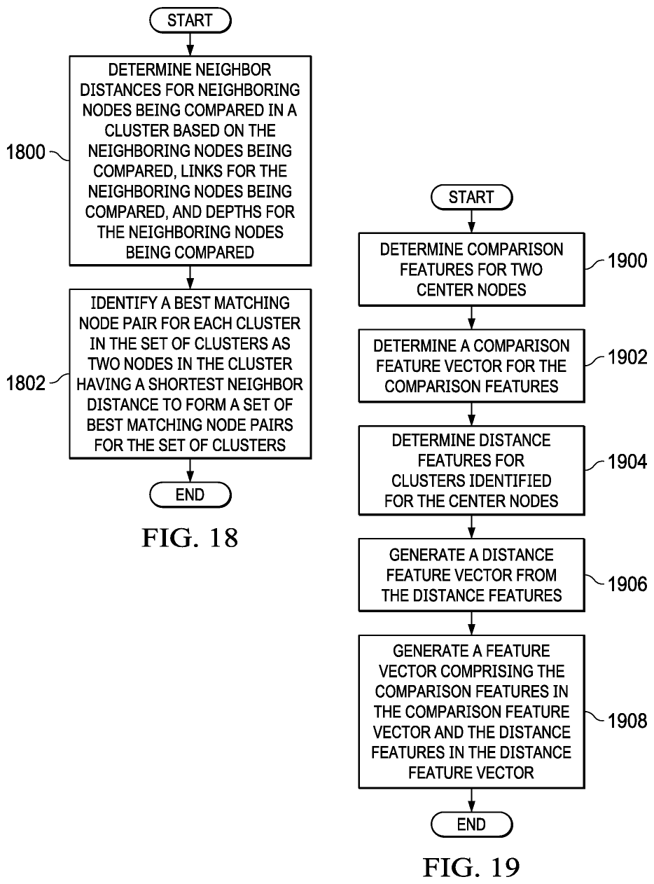

With reference next to FIG. 18, a flowchart of a process for selecting a best matching node pair of neighboring nodes for each cluster is depicted in accordance with an illustrative embodiment. The process in this figure is an example of one implementation for step 1604 in FIG. 16.

The process begins by determining neighbor distances for neighboring nodes being compared in a cluster based on the neighboring nodes being compared, links for the neighboring nodes being compared, and depths for the neighboring nodes being compared (step 1800). The process identifies a best matching node pair for each cluster in the set of clusters as two nodes in the cluster having a shortest neighbor distance to form a set of best matching node pairs for the set of clusters (step 1802). The process terminates thereafter.

Turning next to FIG. 19, a flowchart of a process for generating a feature vector is depicted in accordance with an illustrative embodiment. The process in FIG. 19 can be implemented in hardware, software, or both. When implemented in software, the process can take the form of program code that is run by one or more processor units located in one or more hardware devices in one or more computer systems. This process can be implemented in data management 96 in FIG. 2. In the illustrative example, the process can be implemented in information manager 330 in network data processing system 300 in FIG. 3 and information manager 412 in computer system 410 in FIG. 4.

The process begins by determining comparison features for two center nodes (step 1900). In step 1900, a feature is a characteristic of interest present in information being compared between the two center nodes. The process then determines a comparison feature vector for the comparison features (step 1902). In step 1902, each element in the comparison feature vector identifies the number of occurrences for a particular feature.

For example, in comparing the names in the center node, the features of interest for the comparison of names can be [exact name, name similar, name left out, name unmatched]. In comparing “John Smith Jr.” with “Johnny Smith,” for these features, a count of 1 is present for the elements of the comparison feature vector for the exact name [Smith, Smith]. The second feature, name similar, is present with [John, Johnny]. The third feature, name left out, is present with respect to discerning [Jr., none]. The fourth feature of unmatched is 0 because matches are present. As a result, the comparison feature vector in this example is fv=[1, 1, 1, 0].

The process then determines distance features for clusters identified for the center nodes (step 1904). In step 1904, the features are based on the lowest distance in a cluster of neighboring nodes. In other words, the features are based on the distance determined between the two neighboring nodes in a best matching pair node. The process generates a distance feature vector from the distance features (step 1906). Each element in the distance feature vector indicates a number of occurrences for a particular feature. A feature can be a threshold or range of a distance between the neighboring nodes.

For example, distance features can be [distance_less_than_0.3, distance_between_0.3_0.7, and distance_larger_than_0.7]. In this example, three distance features are present, and the distance feature vector indicates a count of how many nodes are present for each of the particular features.

The process then generates a feature vector comprising the comparison features in the comparison feature vector and the distance features in the distance feature vector (step 1108). The process terminates thereafter. This feature vector can be used in one approach in determining the overall distance between the center nodes.

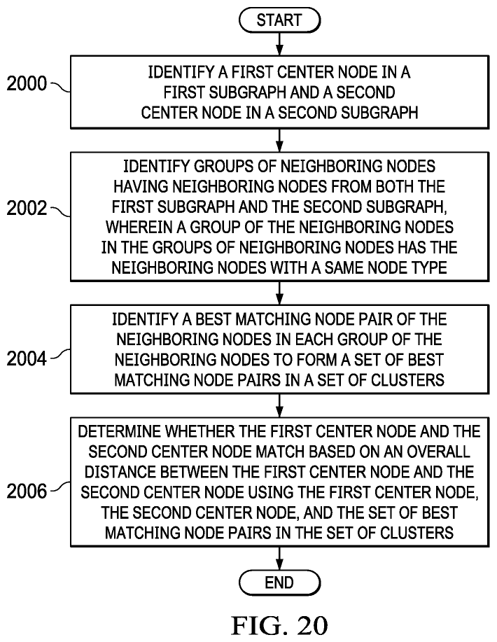

Turning next to FIG. 20, a flowchart of a process for matching center nodes is depicted in accordance with an illustrative embodiment. The process in FIG. 20 can be implemented in hardware, software, or both. When implemented in software, the process can take the form of program code that is run by one or more processor units located in one or more hardware devices in one or more computer systems. This process can be implemented in data management 96 in FIG. 2. In the illustrative example, the process can be implemented in information manager 330 in network data processing system 300 in FIG. 3 or information manager 412 in computer system 410 in FIG. 4. The process in this step can be used to implement step 908 in FIG. 9.

This process is similar to the steps performed in the flowchart in FIG. 10. In illustrative example, creating a set of clusters is an optional step.

The process begins by identifying a first center node in a first subgraph and a second center node in a second subgraph (step 2000). The process identifies groups of neighboring nodes having the neighboring nodes from both the first subgraph and the second subgraph, wherein a group of the neighboring nodes in the groups of the neighboring nodes has the neighboring nodes with a same node type (step 2002).

The process identifies a best matching node pair of the neighboring nodes in each group of neighboring nodes to form a set of best matching node pairs in the set of clusters (step 2004). In step 2004, the neighboring nodes in each best matching node pair comprise a first neighboring node from the first subgraph and a second neighboring node from the second subgraph.

The process determines whether the first center node and the second center node match based on an overall distance between the first center node and the second center node using the first center node, the second center node, and the set of best matching node pairs in the set of clusters (strep 2006). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

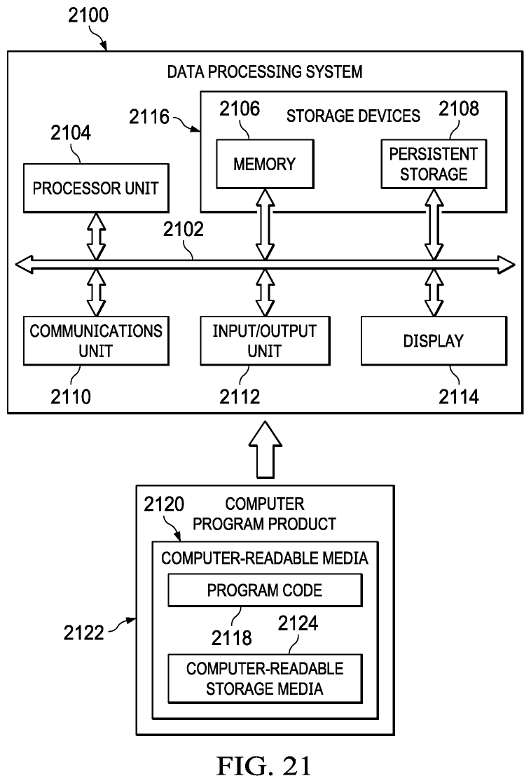

Turning now to FIG. 21, a block diagram of a data processing system is depicted in accordance with an illustrative embodiment. Data processing system 2100 can be used to implement cloud computing nodes 10 in FIG. 1 and hardware components in hardware and software layer 60 in FIG. 2. Data processing system 2100 can also be used to implement server computer 304, server computer 306, and client devices 310 in FIG. 3. Data processing system 2100 can also be used to implement computer system 410 in FIG. 4. In this illustrative example, data processing system 2100 includes communications framework 2102, which provides communications between processor unit 2104, memory 2106, persistent storage 2108, communications unit 2110, input/output (I/O) unit 2112, and display 2114. In this example, communications framework 2102 takes the form of a bus system.

Processor unit 2104 serves to execute instructions for software that can be loaded into memory 2106. Processor unit 2104 includes one or more processors. For example, processor unit 2104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 2104 can may be implemented using one or more heterogeneous processor systems in which a main processor is present with secondary processors on a single chip. As another illustrative example, processor unit 2104 can be a symmetric multi-processor system containing multiple processors of the same type on a single chip.

Memory 2106 and persistent storage 2108 are examples of storage devices 2116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 2116 may also be referred to as computer-readable storage devices in these illustrative examples. Memory 2106, in these examples, can be, for example, a random-access memory or any other suitable volatile or non-volatile storage device. Persistent storage 2108 may take various forms, depending on the particular implementation.

For example, persistent storage 2108 may contain one or more components or devices. For example, persistent storage 2108 can be a hard drive, a solid-state drive (SSD), a flash memory, a rewritable optical disk, a rewritable magnetic tape, or some combination of the above. The media used by persistent storage 2108 also can be removable. For example, a removable hard drive can be used for persistent storage 2108.

Communications unit 2110, in these illustrative examples, provides for communications with other data processing systems or devices. In these illustrative examples, communications unit 2110 is a network interface card.

Input/output unit 2112 allows for input and output of data with other devices that can be connected to data processing system 2100. For example, input/output unit 2112 may provide a connection for user input through at least one of a keyboard, a mouse, or some other suitable input device. Further, input/output unit 2112 may send output to a printer. Display 2114 provides a mechanism to display information to a user.

Instructions for at least one of the operating system, applications, or programs can be located in storage devices 2116, which are in communication with processor unit 2104 through communications framework 2102. The processes of the different embodiments can be performed by processor unit 2104 using computer-implemented instructions, which may be located in a memory, such as memory 2106.

These instructions are program instruction and are also referred to as program code, computer usable program code, or computer-readable program code that can be read and executed by a processor in processor unit 2104. The program code in the different embodiments can be embodied on different physical or computer-readable storage media, such as memory 2106 or persistent storage 2108.

Program code 2118 is located in a functional form on computer-readable media 2120 that is selectively removable and can be loaded onto or transferred to data processing system 2100 for execution by processor unit 2104. Program code 2118 and computer-readable media 2120 form computer program product 2122 in these illustrative examples. In the illustrative example, computer-readable media 2120 is computer-readable storage media 2124.

Computer-readable storage media 2124 is a physical or tangible storage device used to store program code 2118 rather than a medium that propagates or transmits program code 2118. Computer-readable storage media 2124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 2118 can be transferred to data processing system 2100 using a computer-readable signal media. The computer-readable signal media are signals and can be, for example, a propagated data signal containing program code 2118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 2120” can be singular or plural. For example, program code 2118 can be located in computer-readable media 2120 in the form of a single storage device or system. In another example, program code 2118 can be located in computer-readable media 2120 that is distributed in multiple data processing systems. In other words, some instructions in program code 2118 can be located in one data processing system while other instructions in program code 2118 can be located in one data processing system. For example, a portion of program code 2118 can be located in computer-readable media 2120 in a server computer while another portion of program code 2118 can be located in computer-readable media 2120 located in a set of client computers.

The different components illustrated for data processing system 2100 are not meant to provide architectural limitations to the manner in which different embodiments can be implemented. In some illustrative examples, one or more of the components may be incorporated in or otherwise form a portion of, another component. For example, memory 2106, or portions thereof, may be incorporated in processor unit 2104 in some illustrative examples. The different illustrative embodiments can be implemented in a data processing system including components in addition to or in place of those illustrated for data processing system 2100. Other components shown in FIG. 21 can be varied from the illustrative examples shown. The different embodiments can be implemented using any hardware device or system capable of running program code 2118.

Thus, the illustrative examples provide a computer-implemented method, computer system, and computer program product for matching information. A first center node in a first subgraph and a second center node in a second subgraph are identified by a computer system. Groups of neighboring nodes having the neighboring nodes from both the first subgraph and the second subgraph are identified by the computer system. A group of the neighboring nodes in the groups of the neighboring nodes has the neighboring nodes with a same node type. A set of clusters is created by the computer system from each group of the neighboring nodes such that each cluster in the set of clusters has the neighboring nodes from both the first subgraph and the second subgraph. A best matching node pair of the neighboring nodes is identified by the computer system in each cluster in the set of clusters to form a set of best matching node pairs in the set of clusters, wherein the neighboring nodes in the best matching node pair comprise a first neighboring node from the first subgraph and a second neighboring node from the second subgraph. Whether the first center node and the second center node match based on an overall distance between the first center node and the second center node using the first center node, the second center node, and the set of best matching node pairs in the set of clusters is determined by the computer system.

As a result, the different illustrative examples can reduce at least one of the amount of time or resources used in determining whether pieces of information are matching as compared to current techniques that do not compare center nodes and the neighboring nodes in the subgraphs for the center nodes. Further, different illustrative examples can also increase the accuracy in matching pieces of information in at least first order matching or first second order matching.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for matching information, the method comprising:
identifying, by a computer system, a first center node in a first subgraph and a second center node in a second subgraph;
identifying, by the computer system, groups of neighboring nodes having the neighboring nodes from both the first subgraph and the second subgraph, wherein a group of the neighboring nodes in the groups of the neighboring nodes has the neighboring nodes with a same node type;
identifying, by the computer system, a best matching node pair of the neighboring nodes in each group of the neighboring nodes to form a set of best matching node pairs, wherein each best matching node pair comprises a first neighboring node from the first subgraph and a second neighboring node from the second subgraph; and
determining, by the computer system, whether the first center node and the second center node match using the first center node, the second center node, and the set of best matching node pairs.

2. The method of claim 1 further comprising:
creating, by the computer system, a set of clusters from each group of the neighboring nodes such that each cluster in the set of clusters has the neighboring nodes from both the first subgraph and the second subgraph, wherein identifying, by the computer system, the best matching node pair of the neighboring nodes in each group of the neighboring nodes to form the set of best matching node pairs, wherein the neighboring nodes in the best matching node pair comprises the first neighboring node from the first subgraph and the second neighboring node from the second subgraph comprises:
identifying, by the computer system, the best matching node pair of the neighboring nodes in each cluster in the set of clusters to form the set of best matching node pairs, wherein each best matching node pair comprises the first neighboring node from the first subgraph and the second neighboring node from the second subgraph.

3. The method of claim 1, wherein identifying, by the computer system, the groups of the neighboring nodes for the neighboring nodes from both the first subgraph and the second subgraph, wherein the group of the neighboring nodes in the groups of the neighboring nodes has the neighboring nodes with the same node type comprises:
placing, by the computer system, the neighboring nodes from each subgraph into initial groups based on a node type for the neighboring nodes; and
selecting, by the computer system, each initial group in the initial groups that has the neighboring nodes from both one of the first subgraph of the neighboring nodes and the second subgraph of the neighboring nodes to form the groups of the neighboring nodes having the neighboring nodes from both the first subgraph and the second subgraph.

4. The method of claim 2, wherein creating, by the computer system, the set of clusters from each group of the neighboring nodes such that each cluster in the set of clusters has the neighboring nodes from both the first subgraph and the second subgraph comprises:
creating, by the computer system, candidate clusters within each group of the neighboring nodes in the groups of the neighboring nodes; and
selecting, by the computer system, each cluster in the candidate clusters that has neighboring nodes from both the first subgraph of the neighboring nodes and the second subgraph of the neighboring nodes to form the set of clusters.

5. The method of claim 2, wherein identifying, by the computer system, the best matching node pair in each cluster in the set of clusters comprises:
determining, by the computer system, neighbor distances for the neighboring nodes being compared in a cluster based on the neighboring nodes being compared, links for the neighboring nodes being compared, and depths for the neighboring nodes being compared; and
identifying, by the computer system, the best matching node pair for each cluster in the set of clusters as two nodes in the cluster having a shortest neighbor distance to form the set of best matching node pairs for the set of clusters.

6. The method of claim 5, wherein the neighbor distances for the neighboring nodes in the cluster based on the neighboring nodes being compared, links for the neighboring nodes being compared, and depths for the neighboring nodes being compared are calculated using one of the following equations:
d(x,y)=e^{(log(1-distance(x,y))+log(1-distance(link(X),link(Y)))+log(const}^{^{depth(x,y)}}⁾⁾
where distance(x,y) is a distance between a node x and a node y in the cluster, depth(x,y) is an average depth of a first depth for the node x and a second depth for the node y, and const is a constant value that is greater than 0 and less than or equal to 1; and
d(x,y)=1((1−distance(x,y))*(1−distance(linkₓ,linkY))*const^{depth})
where distance(x,y) is the distance between the node x and the node y in the cluster, depth(x,y) is an average depth of the first depth for the node x and the second depth for the node y, and const is the constant value that is greater than 0 and less than or equal to 1.

7. The method of claim 2, wherein determining, by the computer system, whether the first center node and the second center node match using the first center node, the second center node, and the set of best matching node pairs comprises:
determining, by the computer system, an overall distance between the first center node and the second center node using the first center node, the second center node, and the set of best matching node pairs in the set of clusters as follows:
$$overall distance = 1 - \frac{( \begin{matrix}( 1 - distance ( {CenterNode}_{1} , {CenterNode}_{2} ) ) + \\ {\sum }_{n = 1}^{M} ( 1 - dH ( x , y ) )\end{matrix} )}{M + 1}$$
where distance(CenterNode₁, CenterNode₂) is a distance between the first center node and the second center node, dH(x,y) is a distance between neighboring node x and neighboring node y in the best matching node pair, and M is a number of node types with a best matching neighboring node pair in the groups; and
determining, by the computer system, whether the first center node and the second center node match based on the overall distance calculated between the first center node and the second center node.

8. The method of claim 2, wherein determining, by the computer system, whether the first center node and the second center node match using the first center node, the second center node, and the set of best matching node pairs comprises:
comparing, by the computer system, the first center node and the second center node to determine a comparison features for the first center node and the second center node;
determining, by the computer system, distance features from a lowest distance between the neighboring nodes in each cluster in the set of clusters;
determining, by the computer system, an overall distance between the first center node and the second center node using the comparison features and the distance features; and
determining, by the computer system, whether the overall distance is within a threshold for the first center node and the second center node to be matching.

9. The method of claim 8, wherein the overall distance between the first center node and the second center node is determined as follows:
$$overall distance = \frac{max ( c v ) - ( {Σ}_{i = 0}^{n} c v ( i ) * f v ( i ) ) / ( {Σ}_{i = 0}^{n} f v ( i ) )}{max ( c v ) - min ( c v )}$$
where cv(i) is a coefficient vector, fv(i) is a feature vector comprising the comparison features and the distance features, max(cv) is an element in the coefficient vector with a maximum value, min(cv) is the element in the coefficient vector with a minimum value, i is an index value, and n is a number of elements in the feature vector.

10. A method for matching information, the method comprising:
allocating, by a computer system, neighboring nodes of two center nodes in two subgraphs into groups by a node type wherein the groups contain neighboring nodes from both of the two subgraphs;
selecting, by the computer system, a best matching node pair of the neighboring nodes for each group of neighboring nodes using a Hausdorff distance to form a set of best matching node pairs of the neighboring nodes for the group of the neighboring nodes, wherein the best matching node pair in the set of best matching node pairs has a neighboring node from each of the two subgraphs;
determining, by the computer system, an overall distance between the two center nodes using the two center nodes and the set of best matching node pairs of the neighboring nodes, wherein the overall distance between the two center nodes takes into account the set of best matching node pairs for each of the two center nodes; and
determining whether a match is present between the two center nodes based on the overall distance between the two center nodes.

11. The method of claim 10 further comprising:
clustering, by the computer system, neighboring nodes of a same node type in the groups to form a set of clusters, wherein a cluster in the set of clusters has at least one neighboring node from each of the two subgraphs,
wherein selecting, by the computer system, the best matching node pair of the neighboring nodes for each group of the neighboring nodes using the Hausdorff distance to form the set of best matching node pairs of the neighboring nodes for the group of the neighboring nodes, wherein the best matching node pair in the set of best matching node pairs has a neighboring node from each of the two subgraphs comprises:
selecting, by the computer system, the best matching node pair of the neighboring nodes for each cluster using the Hausdorff distance to form the set of best matching node pairs of the neighboring nodes for the set of clusters, wherein the best matching node pair in the set of best matching node pairs has a neighboring node from each of the two subgraphs.

12. The method of claim 11, wherein allocating, by the computer system, the neighboring nodes of the two center nodes in the two subgraphs into the groups by the node type wherein the groups contain the neighboring nodes from both of the two subgraphs comprises:
placing, by the computer system, the neighboring nodes from each subgraph of the two subgraphs into initial groups based on the node type for the neighboring nodes; and
selecting, by the computer system, each initial group in the initial groups that has the neighboring nodes from both of the two subgraphs form the groups.

13. An information management system comprising:
a computer system that executes program instructions to:
identify a first center node in a first subgraph and a second center node in a second subgraph;
identify groups of neighboring nodes having the neighboring nodes from both the first subgraph and the second subgraph, wherein a group of the neighboring nodes in the groups of the neighboring nodes has the neighboring nodes with a same node type;
identify a best matching node pair of the neighboring nodes in each group of the neighboring nodes to form a set of best matching node pairs, wherein each best matching node pair comprise a first neighboring node from the first subgraph and a second neighboring node from the second subgraph; and
determine whether the first center node and the second center node match using the first center node, the second center node, and the set of best matching node pairs.

14. The information management system of claim 13, wherein the computer system executes program instructions to:
create a set of clusters from each group of the neighboring nodes such that each cluster in the set of clusters has the neighboring nodes from both the first subgraph and the second subgraph, wherein in identifying the best matching node pair of the neighboring nodes in each group of the neighboring nodes to form a set of best matching node pairs, wherein the neighboring nodes in the best matching node pair comprises the first neighboring node from the first subgraph and the second neighboring node from the second subgraph, the computer system executes program instructions to:
identify the best matching node pair of the neighboring nodes in each cluster in the set of clusters to form the set of best matching node pairs, wherein each best matching node pair comprises the first neighboring node from the first subgraph and the second neighboring node from the second subgraph.

15. The information management system of claim 13, wherein in identifying the groups of the neighboring nodes having the neighboring nodes from both the first subgraph and the second subgraph, wherein the group of the neighboring nodes in the groups of the neighboring nodes has the neighboring nodes with the same node type, the computer system executes the program instructions to:
place the neighboring nodes from each subgraph into initial groups based on a node type for the neighboring nodes; and
select each initial group in the initial groups that has the neighboring nodes from both one of the first subgraph of the neighboring nodes and the second subgraph of the neighboring nodes to form the groups of the neighboring nodes having the neighboring nodes from both the first subgraph and the second subgraph.

16. The information management system of claim 14, wherein in creating the set of clusters from each group of the neighboring nodes such that each cluster in the set of clusters has the neighboring nodes from both the first subgraph and the second subgraph, the computer system executes the program instructions to:
create candidate clusters within each group of the neighboring nodes in the groups of the neighboring nodes; and
select each cluster in the candidate clusters that has neighboring nodes from both the first subgraph of the neighboring nodes and the second subgraph of the neighboring nodes to form the set of clusters.

17. The information management system of claim 14, wherein in identifying the best matching node pair in each cluster in the set of clusters, the computer system executes the program instructions to:
determine neighbor distances for the neighboring nodes being compared in a cluster based on the neighboring nodes being compared, links for the neighboring nodes being compared, and depths for the neighboring nodes being compared; and
identify the best matching node pair for each cluster in the set of clusters as two nodes in the cluster having a shortest neighbor distance to form the set of best matching node pairs for the set of clusters.

18. The information management system of claim 17, wherein the neighbor distances for the neighboring nodes in the cluster based on the neighboring nodes being compared, links for the neighboring nodes being compared, and depths for the neighboring nodes being compared are calculated using one of the following equations:
d(x,y)=e^{(log(1-distance(x,y))+log(1-distance(link(X),link(Y)))+log(const}^{^{depth(x,y)}}⁾⁾
where distance(x,y) is a distance between a node x and a node y in the cluster, depth(x,y) is an average depth of a first depth for the node x and a second depth for the node y, and const is a constant value that is greater than 0 and less than or equal to 1; and
d(x,y)=1((1−distance(x,y))*(1−distance(linkₓ,linkY))*const^{depth})
where distance(x,y) is the distance between the node x and the node y in the cluster, depth(x,y) is an average depth of the first depth for the node x and the second depth for the node y, and const is the constant value that is greater than 0 and less than or equal to 1.

19. The information management system of claim 14, wherein in determining whether the first center node and the second center node match using the first center node, the second center node, and the set of best matching node pairs, the computer system executes the program instructions to:
determine an overall distance between the first center node and the second center node using the first center node, the second center node, and the set of best matching node pairs in the set of clusters as follows:
$$overall distance = 1 - \frac{( \begin{matrix}( 1 - distance ( {CenterNode}_{1} , {CenterNode}_{2} ) ) + \\ {\sum }_{n = 1}^{M} ( 1 - dH ( x , y ) )\end{matrix} )}{M + 1}$$
where distance(CenterNode₁, CenterNode₂) is a distance between the first center node and the second center node, dH(x,y) is a distance between neighboring node x and neighboring node y in the best matching node pair, and M is a number of node types with a best matching neighboring node pair in the groups; and
determine whether the first center node and the second center node match based on the overall distance calculated between the first center node and the second center node.

20. The information management system of claim 19, wherein in determining whether the first center node and the second center node match using the first center node, the second center node, and the set of best matching node pairs in the set of clusters, the computer system executes the program instructions to:
compare the first center node and the second center node to determine comparison features for the first center node and the second center node;
determine distance features from a lowest distance between neighboring nodes in each cluster in the set of clusters;
determine the overall distance between the distance between the first center node and the second center node using the comparison features and the distance features; and
determine whether the overall distance is within a threshold for the first center node and the second center node to be matching.

21. The information management system of claim 20, wherein the overall distance between the first center node and the second center node is determined as follows:
$$overall distance = \frac{max ( c v ) - ( {Σ}_{i = 0}^{n} c v ( i ) * f v ( i ) ) / ( {Σ}_{i = 0}^{n} f v ( i ) )}{max ( c v ) - min ( c v )}$$
where cv(i) is a coefficient vector, fv(i) is a feature vector comprising the comparison features and the distance features, max(cv) is an element in the coefficient vector with a maximum value, min(cv) is the element in the coefficient vector with a minimum value, i is an index value, and n is a number of elements in the feature vector.

22. An information management system comprising:
a computer system that executes program instructions to:
allocate neighboring nodes of two center nodes in two subgraphs into groups by a node type wherein the groups contain the neighboring nodes from both of the two subgraphs;
select a best matching node pair of the neighboring nodes for each group of the neighboring nodes using a Hausdorff distance to form a set of best matching node pairs of the neighboring nodes for the group of the neighboring nodes, wherein the best matching node pair in the set of best matching node pairs has a neighboring node from each of the two subgraphs;
determine an overall distance between the two center nodes using the two center nodes and the set of best matching node pairs of the neighboring nodes, wherein the overall distance between the two center nodes takes into account the set of best matching node pairs for each of the two center nodes; and
determine whether a match is present between the two center nodes based on the overall distance between the two center nodes.

23. The information management system of claim 22, wherein the computer system executes the program instructions to:
cluster the neighboring nodes a same node type in the groups to form a set of clusters, wherein a cluster in the set of clusters has at least one neighboring node from each of the two subgraphs, wherein selecting the best matching node pair of the neighboring nodes for each group of the neighboring nodes using the Hausdorff distance to form the set of best matching node pairs of the neighboring nodes for the group of the neighboring nodes, wherein the best matching node pair in the set of best matching node pairs has a neighboring node from each of the two subgraphs, the computer system executes the program instructions to:
select the best matching node pair of the neighboring nodes for each cluster using the Hausdorff distance to form the set of best matching node pairs of the neighboring nodes for the set of clusters, wherein the best matching node pair in the set of best matching node pairs has a neighboring node from each of the two subgraphs.

24. The information management system of claim 22, wherein in allocating the neighboring nodes of the two center nodes in the two subgraphs into the groups by the node type wherein the groups contain the neighboring nodes from both of the two subgraphs, the computer system executes the program instructions to:
place the neighboring nodes from each subgraph of the two subgraphs into initial groups based on the node type for the neighboring nodes; and
select each initial group in the initial groups that has the neighboring nodes from both of the two subgraphs form the groups.

25. A computer program product for matching information, the computer program product comprising a computer-readable storage medium having program instructions embodied therewith, the program instructions executable by a computer system to cause the computer to perform a method comprising:
identifying, by the computer system, a first center node in a first subgraph and a second center node in a second subgraph;
identifying, by the computer system, groups of neighboring nodes having the neighboring nodes from both the first subgraph and the second subgraph, wherein a group of the neighboring nodes in the groups of the neighboring nodes has the neighboring nodes with a same node type;
identifying, by the computer system, a best matching node pair of the neighboring nodes in each group of the neighboring nodes to form a set of best matching node pairs in the set of clusters, wherein the neighboring nodes in the best matching node pair comprise a first neighboring node from the first subgraph and a second neighboring node from the second subgraph; and
determining, by the computer system, whether the first center node and the second center node match using the first center node, the second center node, and the set of best matching node pairs.
